(19) United States
(12) Patent Application Publication
(10) Pub. No.: US 2026/0195137 A1
(43) Pub. Date: Jul. 9, 2026

(54) PROCESSOR INCLUDING RESPONSE HANDLING BLOCK, OPERATION METHOD THEREOF, AND SYSTEM INCLUDING THE SAME

(71) Applicant: Samsung Electronics Co., Ltd., Suwon-si, Gyeonggi-do (KR)

(72) Inventors: Jongmin KIM, Suwon-si (KR); Taewan KIM, Suwon-si (KR); Kyungsik UM, Suwon-si (KR); Minsik OH, Suwon-si (KR); Joohyeong YOON, Suwon-si (KR); Youngjin CHO, Suwon-si (KR)

(73) Assignee: Samsung Electronics Co., Ltd., Suwon-si, Gyeonggi-do (KR)

(21) Appl. No.: 19/289,804

(22) Filed: Aug. 4, 2025

(30) Foreign Application Priority Data
Jan. 3, 2025 (KR) 10-2025-0001017

(51) Int. Cl. G06F 9/38; G06F 9/30

(52) U.S. Cl. CPC G06F 9/3858; G06F 9/30101; G06F 9/30123

(57) ABSTRACT

Some example embodiments provide a processor including a processing core block configured to execute one or more first instructions and write first information of a first operation and first data on a first context, and a response handling block configured to receive the first context from the processing core block and manage a first response corresponding to the first operation indicated by a last instruction lastly executed by the processing core block. The processing core block configured to input the first context to the response handling block and perform context switching from the first context to a second context in response to the last instruction lastly executed by the processing core block indicating a portion of the first operation as having longer latency than a threshold value. The response handling block configured to receive the first response, write the first response in the first context, and update the first context.

### CROSS-REFERENCE TO RELATED APPLICATION

This application claims priority under 35 U.S.C. § 119 to Korean Patent Application No. 10-2025-0001017 filed on Jan. 3, 2025, in the Korean Intellectual Property Office, the disclosures of which are incorporated by reference herein in its entirety.

### BACKGROUND

Some example embodiments of the present inventive concepts described herein relate to a semiconductor device such as a processor, and more particularly, relate to a processor including a response handler, an operation method thereof, and/or a system including the same.

A processor may efficiently execute a plurality of instructions through a pipe line operation. The processor may shorten a total of instruction execution operation time through the pipe line operation. The processor may efficiently execute a plurality of instructions by performing different operations respectively corresponding to the plurality of instructions for each period such as a clock period.

Some of the instructions which the processor executes may require or alternatively, utilize a longer latency than a threshold value. In some example embodiments, despite the pipe line operation of the processor, a total of the operation time may become longer depending on the longer latency than the threshold value. Accordingly, it may be advantageous to provide a processor capable of more efficiently managing an operation whose latency is long and shortening a total of the operation time and/or an operation method thereof.

### SUMMARY

Some example embodiments of the present inventive concepts provide a processor capable of more efficiently managing an operation whose latency is long and/or shortening a total of operation time, an operation method thereof, and/or a system including the same.

According to some example embodiments, a processor includes a first processing core block configured to execute one or more first instructions and write first information of a first operation and first data on a first context, and a response handling block configured to receive the first context from the first processing core block and manage a first response corresponding to the first operation indicated by a last instruction of the one or more first instructions lastly executed by the first processing core block. The first processing core block inputs the first context to the response handling block and performs context switching from the first context to a second context in response to the last instruction lastly executed by the first processing core block indicating a portion of the first operation as having a longer latency than a threshold value. The response handling block receives the first response, writes the first response in the first context, and updates the first context.

According to some example embodiments, an operation method of a processor includes executing one or more first instructions of one or more first tasks, switching a first context to a second context, the first context including first information of a first operation and storing first data, writing second information of a second operation and second data in the second context, waiting for a first response of the first operation, and executing one or more second instructions of one or more second tasks. A last instruction lastly executed from among the one or more first instructions indicates a portion of the first operation having a longer latency than a threshold value, and the execution of the one or more second instructions and the waiting for the first response of the first operation are performed to at least partially overlap each other.

According to some example embodiments, an electronic device includes a processor configured to control the electronic device and perform a process for a first operation of the electronic device, and a memory configured to store an instruction and first data for a second operation of the processor. The processor including a processing core block configured to execute one or more first instructions and write information of a third operation and second data on a first context, and a response handling block configured to receive the first context from the processing core block and manage a first response corresponding to the third operation indicated by a last instruction of the one or more first instructions lastly executed by the processing core block.

According to some example embodiments, an operating method of an electronic device including a processor and a memory comprises, executing, by a processing core block, one or more first instructions, the processor including a processing core block and a response handling block; writing, by the processing core block, information of a first operation and first data on a first context; sending, by the processing core block, the first context to the response handling block; receiving, by the response handling block, the first context; and managing, by the response handling block, a first response corresponding to the first operation indicated by a last instruction of the one or more first instructions lastly executed by the processing core block.

In some example embodiments, the method includes inputting the first context to the response handling block and performing context switching from the first context to a second context by the processing core block in response to the last instruction lastly executed by the processing core block indicating that a portion of the first operation has a longer latency than a threshold value; receiving, by the response handling block, the first response; writing, by the response handling block, the first response in the first context; and updating, by the response handling block, the first context.

In some example embodiments, the first operation having the longer latency than the threshold value is a data load operation in which a cache miss occurs.

### BRIEF DESCRIPTION OF THE DRAWINGS

The above and other objects and features of the present inventive concepts will become apparent by describing in detail some example embodiments thereof with reference to the accompanying drawings.

FIG. 1 is a block diagram illustrating an electronic device, according to some example embodiments.

FIG. 2 is a diagram illustrating an example of a pipe line operation of a processor of FIG. 1, according to some example embodiments.

FIG. 3 is a block diagram illustrating an example of a processor of FIG. 1, according to some example embodiments.

FIG. 4 is a diagram illustrating an example of a context of FIG. 3, according to some example embodiments.

FIG. 5 is a flowchart illustrating an example of an operation method of a processor of FIG. 3, according to some example embodiments.

FIG. 6 is a diagram illustrating an example of an operation of a processor of FIG. 3 over time, according to some example embodiments.

FIG. 7 is a flowchart illustrating an example of an operation method of a response handling block of FIG. 3, according to some example embodiments.

FIG. 8 is a block diagram illustrating an example of a response handling block of FIG. 3, according to some example embodiments.

FIG. 9 is a block diagram illustrating an example of a processor of FIG. 1, according to some example embodiments.

FIG. 10 is a flowchart illustrating an example of an operation method of a processor of FIG. 9, according to some example embodiments.

FIG. 11 is a diagram illustrating an example of an operation of a processor of FIG. 9 over time, according to some example embodiments.

FIG. 12 is a block diagram illustrating an example of a processor of FIG. 1, according to some example embodiments.

FIG. 13 is a block diagram illustrating an electronic device, according to some example embodiments.

FIG. 14 is a block diagram illustrating a host-storage system, according to some example embodiments.

### DETAILED DESCRIPTION

Below, some example embodiments of the present inventive concepts will be described in detail and clearly to such an extent that an ordinary one in the art easily carries out the present inventive concepts.

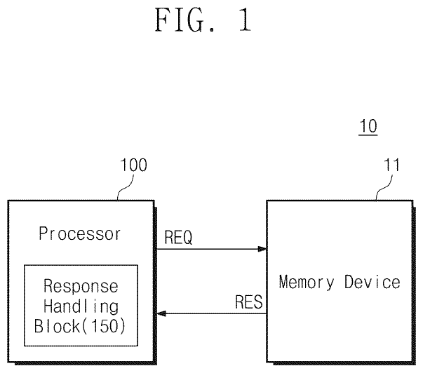

FIG. 1 is a block diagram illustrating an electronic device, according to some example embodiments. Referring to FIG. 1, an electronic device 10 may include a processor 100 and a memory device 11. In some example embodiments, the electronic device 10 may be one of various devices or may be included in one of various devices. For example, the electronic device 10 may be one of a personal computer (PC), a smartphone, a laptop PC, a tablet PC, a server, a cloud device, a data center, and/or various controllers (e.g., an electronic control unit (ECU) and/or a transmission control unit (TCU) of an automotive system) or may be included in one thereof. The above examples of the electronic device 10 are provided as an example, but example embodiments are not limited thereto.

The memory device 11 may store data necessary and/or advantageous for the operation of the electronic device 10. In some example embodiments, the memory device 11 may store data necessary and/or advantageous for the operation of the processor 100. For example, the memory device 11 may store one or more instructions which the processor 100 is configured to execute and/or data which are used to execute the instructions.

In some example embodiments, the memory device 11 may be a volatile memory device or may include a volatile memory device. For example, the memory device 11 may be one of a dynamic random access memory (DRAM) or a static RAM (SRAM) and/or may include one or more of the DRAM and the SRAM. In some example embodiments, the memory device 11 may generate a response RES corresponding to a request REQ of the processor 100 and may transmit and/or send the response RES to the processor 100. For example, the memory device 11 may transmit and/or send the response RES including the corresponding data to the processor 100 in response to a data transmission request REQ of the processor 100.

The processor 100 may control the operation of the electronic device 10 and/or may perform a process necessary and/or advantageous for the operation of the electronic device 10. For example, the processor 100 may perform one or more operations of the electronic device 10 and/or may control the controls of the electronic device 10. In some example embodiments, the processor 100 may execute one or more instructions. In some example embodiments, based on executing one or more instructions, the processor 100 may perform one or more tasks and/or may execute one or more threads including one or more tasks. For example, the processor 100 may execute one or more instructions included in each of one or more tasks included in one thread. For example, the processor 100 may be configured to execute one or more instructions included in each task of one or more tasks, each task of the one or more tasks included in at least one thread.

In some example embodiments, the processor 100 may include a cache memory. For example, the processor 100 may execute an instruction which is stored in the memory device 11 or the cache memory. In some example embodiments, the processor 100 may generate the request REQ for data or an instruction and may transmit and/or send the request REQ to the memory device 11.

In some example embodiments, the processor 100 may be a general purpose processor and/or a specific purpose processor. For example, the processing 100 may include a central processing unit (CPU), or a general purpose processor such as an application processor (AP). In some example embodiments, the processor 100 may be a graphics processing unit (GPU), a neural processing unit (NPU), a tensor processing unit (TPU), a neuromorphic processor (NP), a data processing unit (DPU), and/or a special purpose processor such as a combination thereof. Below, the description will be given based on an example in which the processor 100 is a general purpose processor, but it should be understood that example embodiments are not limited thereto, and in some example embodiments, the present inventive concepts may be applied to special purpose processors and/or is changed or applied without departing from the scope and spirit of the present inventive concepts.

In some example embodiments, the processor 100 may manage a storage space, based on a memory hierarchical structure. For example, the processor 100 may use an internal cache memory as a level 1(L1 ) cache and may use the memory device 11 as a level 2(L2 ) cache. In some example embodiments, the processor 100 may include and/or execute an operating system. For example, based on the operating system, the processor 100 may perform operations such as scheduling of an instruction(s), a task(s), and/or a thread(s) and may optimize the instruction(s) execution of the processor 100.

Referring to FIG. 1, the processor 100 may include a response handling block 150. The response handling block 150 may manage the response RES received from the memory device 11. In some example embodiments, the response handling block 150 may detect that the response RES is received from the memory device 11. For example, the response handling block 150 may detect that the response RES (e.g., including data and/or an instruction) corresponding to the request REQ of data generated according to the data load operation execution of the processor 100 is input to the processor 100.

The processor 100 may manage the entire latency of an operation and/or a process through the response handling block 150. In some example embodiments, the processor 100 may efficiently manage the latency of an operation having a longer latency than a threshold value through the response handling block 150. For example, when the processor 100 performs a data load operation having a longer latency than the threshold value, the processor 100 may perform a data request REQ, may receive the response RES including data corresponding to the request REQ through the response handling block 150, and may write the response RES in a target register. In some example embodiments, independently of the response handling block 150 and/or in parallel with the response handling block 150, the processor 100 may execute any other instruction(s), may perform any other task(s), and/or may execute any other thread(s).

In some example embodiments, the operation having the longer latency than the threshold value may be an operation whose latency is greater than the threshold value. In some example embodiments, the operation having the longer latency than the threshold value may be an operation in which a cycle per instruction (CPI) of an instruction indicating the operation or corresponding to the operation is greater than the threshold value. For example, an operation having a long latency may be an operation such as a data load operation in which a cache miss occurs, a multi-bit multiplying operation, a multi-bit dividing operation, or a large size memory copy operation. In some example embodiments, the operation having the longer latency than the threshold value will be described based on the data load operation in which a cache miss occurs, but it should be understood that example embodiments are not limited thereto, and some example embodiments may be applied to any other operations having a longer latency than the threshold value without modification, and/or is changed and applied without departing from the scope and spirit of the present inventive concepts.

For example, the processor 100 may transmit and/or send the data request REQ, the data request REQ being a portion of the data load operation having the longer latency than the threshold value, and may then perform any other operations (e.g., may execute any other instructions). For example, the data request REQ being a portion of the data load operation may mean that the data request REQ is an instruction of one or more instructions included in the data load operation. In some example embodiments, the processor 100 may receive the response RES from the memory device 11 through the response handling block 150. In some example embodiments, the processor 100 may complete the data load operation by writing the data included in the response RES in the target register through the response handling block 150.

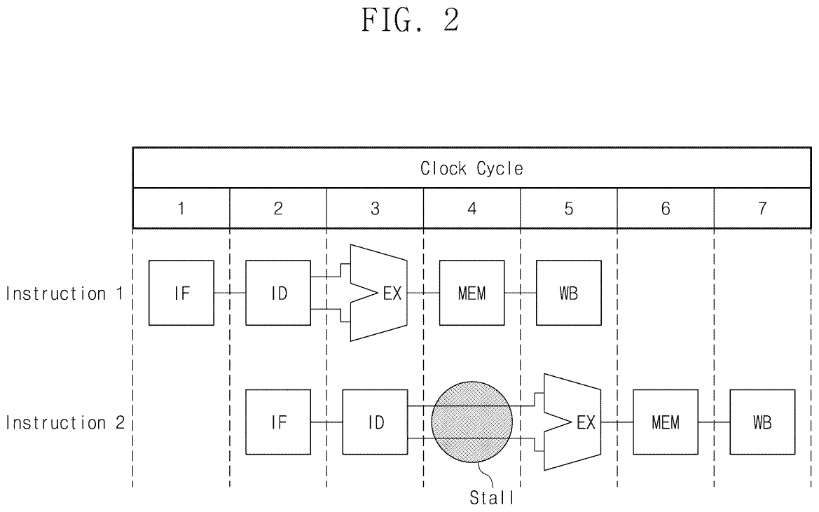

In some example embodiments, the processor 100 may perform pipe line operations. For example, the processor 100 may perform one or more instructions such that some of the one or more instructions overlap each other. The pipe line operation of the processor 100 according to some example embodiments will be described in detail with reference to FIG. 2. In some example embodiments, the processor 100 may perform a plurality of instructions (e.g., in parallel and simultaneously). For example, the processor 100 may execute a plurality of instructions (e.g., efficiently), based on performing a plurality of pipe line operations in parallel.

According to some example embodiments, when some of the instructions executable by the processor 100 are executed, due to the latency of, for example, the data load operation used in the execution of the instructions, the latency may be longer than the threshold value. For example, assuming that the processor 100 performs the pipe line operation on a first instruction and a second instruction, and the second instruction uses a result of an execution result of the first instruction, when the latency of the execution of the first instruction may become longer, the execution of the second instruction may also be delayed. Accordingly, it may be advantageous to reduce a total of instruction execution latency (e.g., a total execution latency of the first instruction and the second instruction) by efficiently managing, by the processor 100, an operation (e.g., the first instruction) having a longer latency than the threshold value.

FIG. 2 is a diagram illustrating an example of a pipe line operation of a processor of FIG. 1, according to some example embodiments. Referring to FIG. 2, an example of the process of executing a first instruction and a second instruction based on a clock cycle is illustrated. In FIG. 2, the processor 100 of FIG. 1 may perform one instruction (e.g., “Instruction 1” illustrated in FIG. 2) over five clock cycles. In some example embodiments, the second instruction (e.g., “Instruction 2” illustrated in FIG. 2) may be an instruction which uses an execution result of the first instruction.

The processor 100 may fetch the first instruction in a first clock cycle (e.g., “instruction fetch (IF)” in FIG. 2). In a second clock cycle, the processor 100 may decode the first instruction (e.g., “instruction decoding (ID)” in FIG. 2) and may simultaneously fetch the second instruction (e.g., “IF” in FIG. 2). In a third clock cycle, the processor 100 may execute the first instruction (e.g., “execute (EX)” in FIG. 2) and may simultaneously decode the second instruction (e.g., “ID” in FIG. 2).

The processor 100 may store an execution result of the first instruction (e.g., “MEM” in FIG. 2) in a fourth clock cycle. The processor 100 may require or alternatively, may utilize the execution result of the first instruction to perform the second instruction, but because the execution result of the first instruction is not loaded in the fourth clock cycle (e.g., has not been written back), a stall may occur in the execution of the second instruction. In a fifth clock cycle, the processor 100 may write back the execution result of the first instruction to a cache memory (e.g., “write back (WB)” in FIG. 2) and may simultaneously execute the second instruction (e.g., “EX” in FIG. 2). The processor 100 may complete the execution of the first instruction in the fifth clock cycle.

The processor 100 may store an execution result of the second instruction in a memory in the sixth clock cycle (e.g., “MEM” in FIG. 2). The processor 100 may write back the execution result of the second instruction to the cache memory in a seventh clock cycle (e.g., “WB” in FIG. 2). The processor 100 may complete the execution of the second instruction in the seventh clock cycle. The instruction executing process described with reference to FIG. 2 is provided as an example, but example embodiments are not limited thereto. For example, it should be understood that in some example embodiments, an additional operation may be included, one or more operations may be skipped, and/or the order of at least some operations may be changed.

In the example described with reference to FIG. 2, a stall corresponding to one clock cycle occurs while the processor 100 performs two instructions (e.g., the first instruction and the second instruction). However, in some example embodiments, when a latency for the processor 100 to receive access-requested data (e.g., through the response RES illustrated in, e.g., FIG. 1) becomes longer, a stall whose length is longer than one clock cycle may occur. This may cause a reduction of performance of the pipe line operation of the processor 100 and an increase in a time (e.g., an amount of time) taken for the processor 100 to execute all instructions. Accordingly, it is advantageous to provide a processor which is capable of an efficient execution of instructions and performance of operations by efficiently managing an operation whose latency is longer than a threshold value. A processor according to some example embodiments of the present inventive concepts will be described with reference to the following drawings.

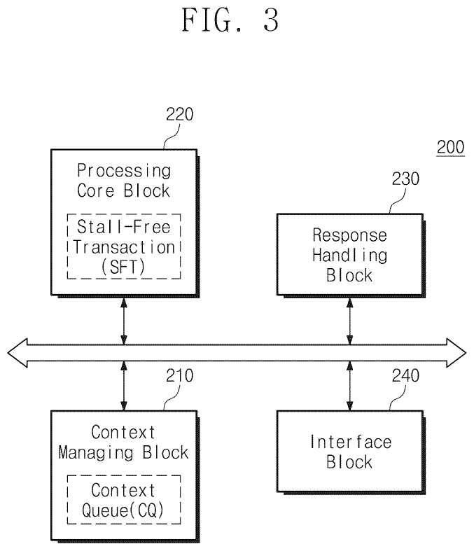

FIG. 3 is a block diagram illustrating an example of a processor of FIG. 1, according to some example embodiments. The processor 200 may correspond to the processor 100 of FIG. 1. Referring to FIG. 3, the processor 200 may include a context managing block 210, a processing core block 220, a response handling block 230, and an interface block 240. The processor 200 according to some example embodiments will be described in detail with reference to FIGS. 1 and 3.

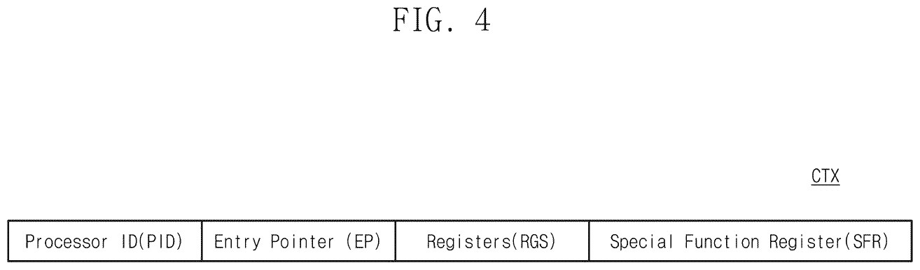

The context managing block 210 may manage one or more contexts of the processor 200. In some example embodiments, a context may include data which indicate a state of a processing core (e.g., the processing core block 220) and/or data that may be necessary or alternatively, desired for the processing core block 220 to execute an instruction. For example, the context may include a processor ID of one or more processing core blocks managing the context, registers storing at least a portion of data which are used for an operation of the processing core block 220 managing the context and/or data that are generated as a result of an operation, and/or a special function register recording the state of the processing core block 220. The context according to some example embodiments will be described in detail with reference to FIG. 4. Still referring to FIG. 3, in some example embodiments, the context managing block 210 may manage one or more contexts based on an arbitrary data structure. For example, the context managing block 210 may manage a context queue CQ including a first context and a second context.

The processing core block 220 may execute one or more instructions. For example, the processing core block 220 may execute one or more instructions to control an operation of the processor 200 and/or to perform a process. In some example embodiments, the processing core block 220 may execute one or more instructions to perform a task including the one or more instructions. In some example embodiments, the processing core block 220 may execute a thread including one or more tasks, based on performing the one or more tasks. For example, the processing core block 220 may execute a first thread, based on executing first instructions in first tasks of the first thread.

In some example embodiments, a thread may include one or more tasks. In some example embodiments, in the thread, an operation such as generate, configure, manage, change, list, scheduling, and/or update may be performed by an arbitrary component. For example, the thread may be generated, configured, changed, listed, scheduled, and/or updated by an operating system (OS) of the processor 200, a user, and/or the processing core block 220. In some example embodiments, in a task, an operation such as generate, configure, manage, change, list, scheduling, and/or update may be performed by an arbitrary component. For example, the task may be generated, configured, changed, listed, scheduled, and/or updated by the operating system of the processor 200, the user, and/or the processing core block 220.

In some example embodiments, the last instruction of the task or a lastly executed instruction may correspond to a portion of an operation that has a longer latency than the threshold value. For example, the lastly executed instruction of the first task may indicate that the data request REQ to the memory device 11, which is a portion of the data load operation, has a longer latency than the threshold value. For example, the last instruction of the first task may not indicate receiving the response RES including data corresponding to the request REQ in the data load operation from the memory device 11. In some example embodiments, at least some of instructions included in at least one of a plurality of tasks may correspond to at least a portion of an operation having a longer latency than the threshold value. For example, at least one instruction of the first task (e.g., an instruction not lastly executed from among the instructions of the first task) may indicate at least a portion of an operation having a longer latency than the threshold value (for example, instructions of the second task may not indicate at least a portion of an operation having a longer latency than the threshold value). In some example embodiments, an instruction may indicate whether the instruction indicates an operation (or at least a portion of an operation) having a longer latency than the threshold value, based on a region in the instruction. For example, an instruction may indicate whether the instruction indicates an operation (or at least portion of an operation) having a longer latency than the threshold value, based on an operation code opcode or a reserved region.

The processing core block 220 may generate, change, manage, align, list, and/or update the context. In some example embodiments, the processing core block 220 may write all or a portion of data generated by the operation or an operation form of the processing core block 220 on the context. For example, the processing core block 220 may write information of a task being performed on the context or may write a portion of data generated by the task on the context.

The processing core block 220 may perform context switching. For example, the processing core block 220 may write a state of an operation or data generated by the operation on the first context, may then perform context switching, and may write a state of an operation according to the execution of a next task (or the execution of an instruction) or data of the operation on the second context. In some example embodiments, when an (e.g., immediately) executed instruction indicates that at least a portion of an operation has a longer latency than the threshold value, the processing core block 220 may perform context switching. In some example embodiments, before the context switching, the processing core block 220 may write information of an instruction which the processing core block 220 lastly executes, a state of the processing core block 220, and/or an address of an instruction to be executed next on the switched context (in some example embodiments, the context may include at least a portion of data used for the operation of the processing core block 220 and/or at least a portion of data generated by the operation without modification).

In some example embodiments, the processing core block 220 may perform at least a portion of an operation having a longer latency than the threshold value and may then write an address or a pointer of an instruction to be executed next on the context. For example, the processing core block 220 may write an operation code opcode of the lastly executed instruction and/or information of the lastly executed instruction such as a target register of an operation on the switched context. It should be understood that some example embodiments in which the processing core block 220 performs context switching depending on scheduling (of the operating system) or a control signal (e.g., an interrupt received from the user) also belongs to the scope of the present inventive concepts.

In some example embodiments, the processing core block 220 may execute a plurality of instructions in parallel (e.g., simultaneously). In some example embodiments, the processing core block 220 may execute at least some of the plurality of instructions based on the pipe line operation, so as to overlap each other. For example, the processing core block 220 may execute at least some of the plurality of instructions based on two or more pipe line operations being parallel, simultaneously or so as to overlap each other.

The processing core block 220 may support a stall-free transaction (SFT). The stall-free transaction may be an operation of removing the stall due to an operation having a longer latency than the threshold value such that a total of process time is prevented or mitigated from increasing. In some example embodiments, the processing core block 220 may support the stall-free transaction based on context switching. For example, the processing core block 220 may perform a portion of the operation having the longer latency than the threshold value and may then perform context switching; the processing core block 220 may perform at least some of the execution of any other instructions and a standby of a response in parallel or so as to overlap each other. The processing core block 220 may support and/or implement the stall-free transaction by performing the portion of the operation having the longer latency than the threshold value and simultaneously performing any other operation.

The response handling block 230 may manage a response to a request which the processing core block 220 issues. In some example embodiments, the response handling block 230 may manage a response according to a portion of an operation which the processing core block 220 performs. For example, the response handling block 230 may manage the response RES corresponding to the data request REQ being the portion of the data load operation having the longer latency than the threshold value. In some example embodiments, the response handling block 230 may detect the reception of the response RES of FIG. 1, which corresponds to the request REQ of FIG. 1, issued by the processor 200. For example, the response handling block 230 may wait for the response RES including the data corresponding to the data request REQ being the portion of the data load operation and may detect the reception of the response RES.

The response handling block 230 may receive the context and may manage and update the received context. In some example embodiments, the response handling block 230 may receive a switched context. For example, the response handling block 230 may receive and manage the first context switched by the processing core block 220.

In some example embodiments, the response handling block 230 may manage and update a context based on information written on the context. For example, the response handling block 230 may write a response corresponding to the lastly executed instruction on the context based on information about the lastly executed instruction written on the context.

In some example embodiments, the response handling block 230 may perform at least a portion of a task, based on a context update operation. For example, based on writing data included in the received response RES in the target register, the response handling block 230 may perform the portion of the operation of loading data to the target register and may complete the operation.

In some example embodiments, the response handling block 230 may determine a processing core which will perform a task and may write a determination result on a context. For example, the response handling block 230 may determine the processing core block which will perform the task following the operation having a longer latency than the threshold value and may write the determination result (e.g., the processing core block which will perform the task) on the context. In some example embodiments, the response handling block 230 may write the response RES and/or information about the response RES on the context corresponding to the response RES. For example, the response handling block 230 may write, on the context, information about whether an error occurs in the data included in the response RES. In some example embodiments, an error correction block (not illustrated) configured to correct an error of data received by the processing core block 220 and/or the processor 200 may correct the error included in the response RES.

The response handling block 230 may transfer the updated context to the context managing block 210 and/or the processing core block 220. For example, the response handling block 230 may again transfer the updated context to the processing core block 220 in synchronization with the context switching timing of the processing core block 220. For example, the response handling block 230 may write the updated context in the context queue CQ of the context managing block 210.

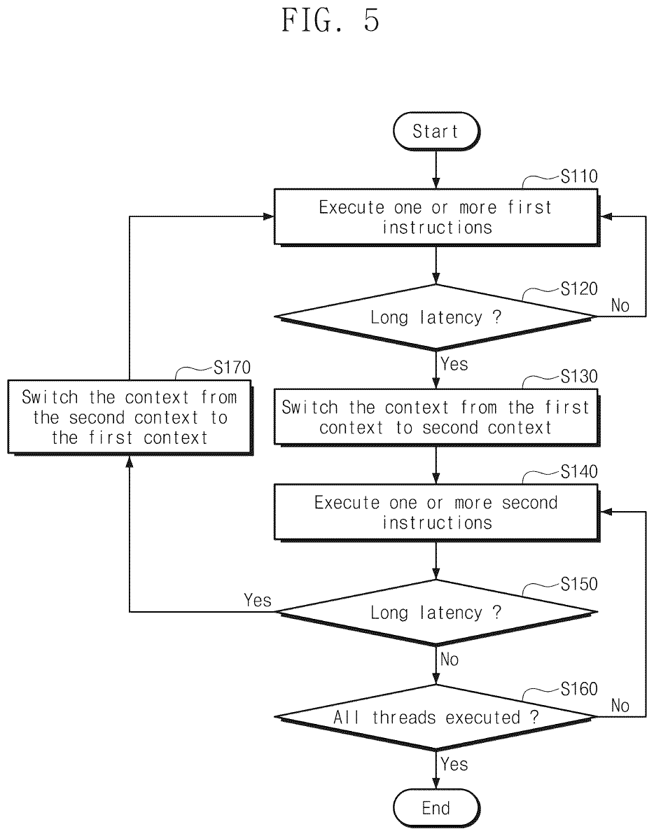

The description is given based on an example in which the response handling block 230 manages one context and waits for and manages a response of the one context, but example embodiments of the present inventive concepts are not limited thereto. It should be understood that some example embodiments, in which the response handling block 230 manages a plurality of contexts and responses respectively corresponding to the plurality of contexts and writes a response corresponding to each of one or more contexts or manages, updates, and/or aligns one or more contexts, also belongs to the scope of the present inventive concepts. The operation of the response handling block 230, according to some example embodiments, will be described in detail with respect to FIGS. 5 to 8.

The interface block 240 may perform data exchange between the processor 200 and an external device. In some example embodiments, the interface block 240 may receive a context or data from a memory device (e.g., the memory device 11 of FIG. 1). In some example embodiments, the interface block 240 may transmit and/or send data generated by the operation of the processor 200 to a memory device (e.g., the memory device 11 of FIG. 1). In some example embodiments, depending on an arbitrary standard and/or protocol, the interface block 240 may receive an instruction and/or data from the memory device (e.g., the memory device 11 of FIG. 1) or may transmit and/or send data to the memory device (e.g., the memory device 11 of FIG. 1).

In some example embodiments, the interface block 240 may transmit and/or send the request REQ generated by the operation of the processor 200 to the external device. For example, the interface block 240 may transmit and/or send the request REQ to the memory device 11 of FIG. 1. In some example embodiments, the interface block 240 may receive the response RES corresponding to the request REQ. For example, the interface block 240 may transmit and/or send the response RES corresponding to the request REQ to the memory device 11 of FIG. 1, and the response RES may include data corresponding to the request REQ. In some example embodiments, the interface block 240 may transmit and/or send the response RES to the response handling block 230.

The blocks illustrated in FIG. 3 and operations of the blocks described with reference to FIG. 3 are provided as an example, and example embodiments are not limited thereto. The blocks of FIG. 3 are distinguished based on functions, not physically distinguished from each other. It should be understood that some example embodiments in which functions of at least some of the blocks of FIG. 3 are performed by any other block also belongs to the scope of the present inventive concepts. For example, it should be understood that some example embodiments in which as well as the processing core block 220, the context managing block 210 performs context switching also belongs to the scope of the present inventive concepts. For another example, it should be understood that some example embodiments in which the context managing block 210 and the response handling block 230 are implemented and/or integrated with one hardware also belongs to the scope of the present inventive concepts. It should be understood that some example embodiments which does not include at least some of the components illustrated in FIG. 3 and/or further includes another component also belongs to the scope of the present inventive concepts. For example, the processor 200 may further include a (local) cache memory block capable of storing an instruction (or a thread), data, and/or the context queue CQ. For example, the context queue CQ may have a queue structure, but example embodiments of the present inventive concepts are not limited thereto. For example, it should be understood that some example embodiments in which the context queue CQ is implemented with a stack or a priority queue and/or in any other data structure also belongs to the scope of the present inventive concepts.

FIG. 4 is a diagram illustrating an example of a context of FIG. 3, according to some example embodiments. Referring to FIG. 4, a context CTX may include a processor ID PID, an entry pointer EP, registers RGS, and a special function register SFR. An example of the processor ID PID, the registers RGS, and the special function register SFR described with reference to FIGS. 3 and 4 is associated with an allocated region or filed in the context CTX, and it should be understood that the example may not correspond to a physical structure.

The processor ID PID may point out a processing core block which will execute a thread and/or may indicate an ID of a processor which generates, changes, and/or updates a context. In some example embodiments, when a processor includes a plurality of processing core blocks, the processor ID PID may point out one processing core block which manages the context CTX and/or receives the context CTX.

The entry pointer EP may point out an address and/or a pointer of an instruction which the processing core block receiving the context CTX will first access. In some example embodiments, the entry pointer EP may point out an address and/or a pointer of an instruction, which will be first executed, from among instructions of one or more tasks in a thread which the processing core block will perform. In some example embodiments, when the context CTX is context switched, the entry pointer EP may be updated (e.g., by the processing core block 220) to point out an instruction of a next task (to be first executed) or a next task (to be performed).

The registers RGS may include at least a portion of data necessary or advantageous for the operation of the processing core block or at least a portion of data generated by the operation. In some example embodiments, the registers RGS may include one or more registers which are capable of storing data to be used for the operation of the processing core block and/or data generated by the operation and have an arbitrary length. In some example embodiments, at least some of the registers RGS may be used to record the response RES which the response handling block 230 receives. For example, one of the registers RGS may be a target register of the last instruction of a task before context switching, and the received response RES may be recorded at the target register.

The special function register SFR may include information of the context CTX and/or information of a processing core block which manages, changes, and/or updates the context CTX. For example, the special function register SFR may be a link register, a program counter, a saved program status register (SPSR), and/or a current program status register (CPSR), and may include one or more thereof, and/or may perform a function of the one or more thereof. In some example embodiments, the special function register SFR may include a state of a processing core block, information of an instruction executed by a processing core block and/or an operation corresponding to the executed instruction, information of the response RES which a response handling block writes, etc.

In some example embodiments, the special function register SFR may include information of an instruction lastly executed by the processing core block 220 and/or information of the request REQ generated according to the lastly executed instruction. For example, the special function register SFR may include information about the request REQ corresponding to the (last) instruction executed before context switching, an operation code opcode of the (last) instruction executed before context switching, etc. In some example embodiments, the response handling block 230 may manage and update the response RES corresponding to the request REQ by referring to the special function register SFR. For example, when the received response RES corresponds to information written on the special function register SFR, the response handling block 230 may write, on the context, information indicating that the response RES is received. In some example embodiments, the response handling block 230 may write the response RES in the target register among the registers RGS by referring to the special function register SFR.

In some example embodiments, when an error is included in the received response RES, the response handling block 230 may write error information of the response RES in the special function register SFR. For example, when an error is included in the response RES, the response handling block 230 may write information about the error of the response RES in a status information region of the special function register SFR. In some example embodiments, the processing core block 220 or the error correction block (not illustrated) included in the processor 200 may correct the error of data included in the response RES by referring to the error of the context. The context CTX described with reference to FIG. 4 is provided as an example, but example embodiments are not limited thereto.

FIG. 5 is a flowchart illustrating an example of an operation method of a processor of FIG. 3, according to some example embodiments. An example of an operation method of the processor 200 according to some example embodiments will be described with reference to FIGS. 3 to 5.

In operation S110, the processor 200 may execute one or more first instructions. For example, the processing 200 may execute one or more first instructions to perform a first operation of the processor 200 and/or to perform a first process of the processor 200. In some example embodiments, the processor 200 may execute one or more first instructions of one or more first tasks in a first thread. In some example embodiments, the processor 200 may execute one or more first instructions through the processing core block 220. For example, the processing core block 220 may perform and/or execute the one or more first tasks and/or one or more first threads, based on executing the one or more first instructions.

In operation S110, the processing core block 220 may write, on a first context, a form and/or information of the first operation or at least a portion of data generated by the first operation. In some example embodiments, the processing core block 220 may start the execution of the one or more first instructions of the one or more first tasks by referring to an entry pointer EP of the first context. For example, the entry pointer EP of the first context may point to a first or alternatively, a start instruction of the one or more first instructions.

In operation S120, the processor 200 may determine a next progress operation, based on whether an instruction of the one or more first instructions to be executed indicates that at least a portion of the first operation has a longer latency than a threshold value. In some example embodiments, the instruction having the longer latency than the threshold value may be the last instruction of the one or more first instructions of a task or may be one of a plurality of instructions of a task. In some example embodiments, the processor 200 may determine whether the instruction indicates that at least a portion of the first operation has the longer latency than the threshold value by referring to the instruction. For example, the processor 200 may determine whether the instruction to be executed indicates that at least a portion of the first operation has a longer latency than the threshold value based on information written on a reserved region of the instruction or an operation code opcode of the instruction.

In some example embodiments, when the instruction to be executed does not indicate that at least a portion of the first operation has a longer latency than the threshold value, “No” in operation S120, the processor 200 may return to operation S110. For example, when the instruction of the one or more first instructions to be executed does not indicate that at least a portion of the first operation has a longer latency than the threshold value, “No” in operation S120, the processor 200 may return to operation S110 and continue executing the one or more first instructions. In some example embodiments, when the instruction to be executed indicates that at least a portion of the first operation has a longer latency than the threshold value, “Yes” in operation S120, the processor 200 may proceed to operation S130. However, this is provided as an example. For example, it should be understood that some example embodiments in which the processor 200 proceeds to operation S140 through context switching depending on, for example, scheduling of the operating system of the processor 200 also belongs to the scope of the present inventive concepts.

In operation S130, the processor 200 may perform context switching to, for example, switch from the first context to a second context. In some example embodiments, the processor 200 may write information of the lastly executed instruction of the one or more first instructions on the first context. For example, when the lastly executed instruction of the one or more first instructions indicating that at least a portion of the first operation has a longer latency than the threshold value indicates the request REQ of FIG. 1 as the portion of the first operation as having the longer latency than the threshold value, the processor 200 may write information about the request REQ and/or the lastly executed instruction in the special function register SFR of the first context. In some example embodiments, the processor 200 may write information of a next instruction (e.g., a subsequent instruction of the one or more first instruction to be executed) of the lastly executed instruction on the first context. For example, the processor 200 may change and/or update the entry pointer EP of the first context to an address and/or a pointer of the next instruction (e.g., subsequent instruction of the one or more first instructions to be executed) of the lastly executed instruction.

In some example embodiments, the processor 200 may transmit and/or send the first context to the response handling block 230. In some example embodiments, the processor 200 may transmit and/or send the second context to the processing core block 220 through the context managing block 210. For example, the context managing block 210 may transmit and/or send the second context in the context queue CQ to the processing core block 220.

In operation S140, the processor 200 may execute one or more second instructions. For example, the processing 200 may execute one or more second instructions to perform a second operation of the processor 200 and/or to perform a second process of the processor 200. In some example embodiments, the processor 200 may execute one or more second instructions of one or more second tasks in a second thread.

In some example embodiments, the processor 200 may execute the one or more second instructions through the processing core block 220. For example, the processing core block 220 may perform and/or execute the one or more second tasks and/or one or more second threads, based on executing the one or more second instructions. In some example embodiments, the processing core block 220 may start the execution of the one or more second instructions by referring to an entry pointer EP of the received second context. In some example embodiments, the processor 200 may write, on the second context, information and/or a form of a second operation or at least portion of data generated by the second operation. The processor 200 may perform operation S140 to be identical and/or similar to operation S110.

In operation S150, the processor 200 may determine a next progress operation, depending on whether an instruction of the one or more second instructions to be executed indicates that at least portion of a second operation has a longer latency than the threshold value. The processor 200 may perform the determination in operation S150 to be identical and/or similar to the determination in operation S120. For example, when the instruction of the one or more second instructions to be executed does not indicate that at least portion of the second operation has a longer latency than the threshold value, “No” in operation S150, the processor 200 may proceed to operation S160. In some example embodiments, when the instruction of the one or more second instructions to be executed indicates that at least a portion of the second operation has the longer latency than the threshold value, “Yes” in operation S150, the processor 200 may proceed to operation S170.

In operation S160, the processor 200 may determine a next progress operation, depending on whether all instructions are executed. For example, the processor 200 may determine the next progress operation depending on whether all of the one or more first instructions and the one or more second instructions have been executed. In some example embodiments, the processor 200 may determine a next progress operation, depending on whether all instructions in one or more threads and/or one or more tasks are executed. For example, when all the instructions are not executed, “No” in operation S160, the processor 200 may return to operation S140. For example, when all the instructions are executed, “Yes” in operation S160, the processor 200 may terminate the operation.

In operation S170, the processor 200 may perform switching from the second context to the first context. In some example embodiments, the processor 200 may transmit and/or send the second context to the response handling block 230. In some example embodiments, the processor 200 may write information of the lastly executed instruction of the one or more second instructions on the second context. In some example embodiments, the processor 200 may write information of a next instruction (e.g., a subsequent instruction of the one or more second instructions) of the lastly executed instruction on the second context. For example, the processor 200 may change and/or update the entry pointer EP of the second context to an address or a pointer of the next instruction of the lastly executed instruction. The processor 200 may perform operation S170 to be identical or similar to operation S130. After operation S170, the processor 200 may return to operation S110.

According to some example embodiments, the processor 200 may wait for the reception of a response RES corresponding to the lastly executed instruction before context switching, through the response handling block 230 before or immediately before operation S170 in operation S140. For example, when the instruction lastly executed of the one or more first instructions before switching of the first context to the second context indicates that the data request REQ of the data load operation (e.g., the first operation) has a longer latency than the threshold value, the response handling block 230 may wait for the response RES including the data corresponding to the request REQ of the data load operation (e.g., the first operation). The response handling block 230 may receive and manage the waiting for the response RES including the data corresponding to the request REQ.

The response handling block 230 may manage, update, and/or align a context before or immediately before operation S170 in operation S140. In some example embodiments, the response handling block 230 may receive the response RES and may perform the remaining portion of the operation corresponding to the instruction lastly executed before context switching. For example, when the instruction of the one or more first instructions lastly executed before context switching indicates that a portion (e.g., the data request REQ) of the data load operation (e.g., the first operation) has a longer latency than the threshold value, the response handling block 230 may write the received response RES on the target register (in the first context) of the data load operation (e.g., the first operation) and may complete the data load operation (e.g., the first operation). The description is given based an example in which the processor 200 performs operations, such as an operation of waiting for, managing, and/or processing the response RES or an operation of updating a context, before or immediately before operation S170 in operation S140 through the response handling block 230, but example embodiments of the present inventive concepts are not limited thereto, and in some example embodiments, the processor 200 may perform operations (e.g., such as the operation of waiting for, managing, and/or processing the response RES or an operation of updating a context) at an arbitrary time point before the switching the context from the second context to the first context in operation S170 after the execution of one or more second instructions in operation S140.

The operation method described with reference to FIG. 5 is provided as an example, and the scope of the present inventive concepts are not limited thereto. It should be understood that some example embodiments in which the order of some of the above operations of FIG. 5 is changed or some example embodiments in which at least some of the above operations of FIG. 5 are performed to overlap with each other also belongs to the scope of the present inventive concepts. It should be understood that some example embodiments in which the operation method of FIG. 5 ends as the processing core block 220 executes all instructions while writing a form or information of an operation on the first context also belongs to the scope of the present inventive concepts. For example, when the processing core block 220 performs context switching without executing an instruction indicating a long latency, the processing core block 220 may transmit and/or send the context to the context queue CQ.

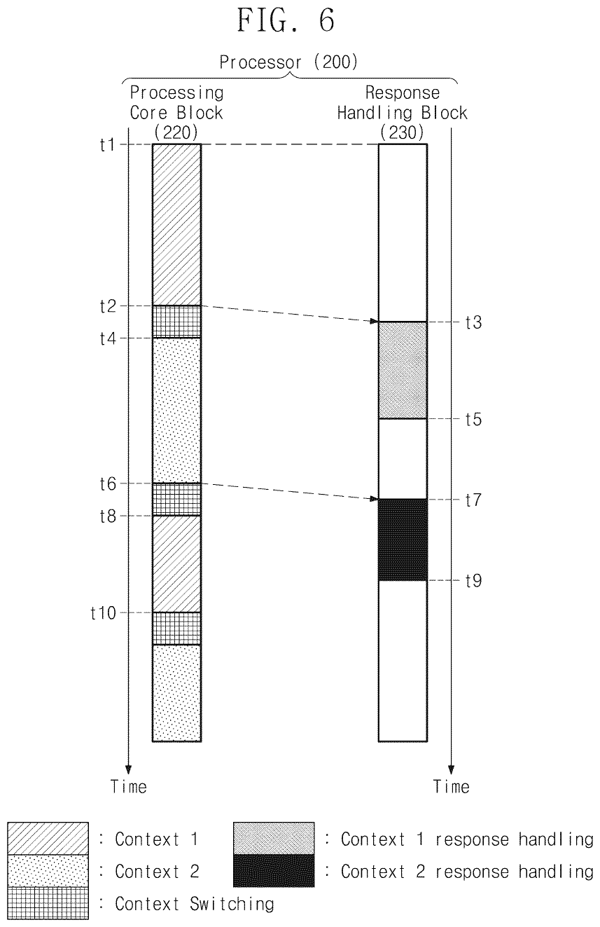

FIG. 6 is a diagram illustrating an operation of a processor of FIGS. 3 to 5, according to some example embodiments. An example of an operation of the processor 200 according to some example embodiments of the present inventive concepts will be described with reference to FIGS. 3 to 6.

Referring to FIG. 3 to FIG. 6, in some example embodiments, at a first time point t1, the processor 200 may start a first operation. From the first time point t1 to a second time point t2, the processing core block 220 may perform one or more first tasks in one or more first threads. At the first time point t1, the processing core block 220 may write an operation state or form of the processing core block 220 and/or at least a portion of data generated by the first operation on the first context. In some example embodiments, from the first time point t1 to the second time point t2, the processing core block 220 may perform a first thread(s) of the one or more first tasks.

At the second time point t2, the processing core block 220 may execute an instruction of one or more first instructions corresponding to the first operation that indicates that at least a portion of the first operation has a longer latency than the threshold value. In some example embodiments, the portion of the first operation indicated as having the longer latency than the threshold value may be a data request REQ. At the second time point t2, the processing core block 220 may perform the data request REQ indicated as being the portion of the data load operation having the longer latency than the threshold value. At the second time point t2, the processing core block 220 may write information of the lastly executed instruction (e.g., the operation code opcode or the target register) on the first context. For example, at the second time point t2, the processing core block 220 may write information on the first context of the executed instruction of the one or more first instructions that indicated the data request REQ as being the portion of the data load operation having the longer latency than the threshold value. In some example embodiments, at the second time point t2, the processing core block 220 may write information of a next instruction of the lastly executed instruction on the first context. For example, at the second time point t2, the processing core block 220 may write information of another instruction of the one or more first instructions that is subsequent to the executed instruction that indicated that the data request REQ is the portion of the data load operation having the longer latency than the threshold value. For example, the processing core block 220 may change and/or update the entry pointer EP of the first context to an address and/or a pointer of the next instruction of the lastly executed instruction.

From the second time point t2 to a fourth time point t4, the processing core block 220 may perform context switching. For example, at the second time point t2, the processing core block 220 may transmit and/or send the first context to the response handling block 230; at a third time point t3, the response handling block 230 may receive the first context and may start to wait for the response RES to the request REQ at the second time point t2. The response handling block 230 may perform a response (RES) waiting and processing operation until a fifth time point t5.

Before (or immediately before) the fourth time point t4, the processing core block 220 may receive the second context. From the fourth time point t4 to a sixth time point t6, the processing core block 220 may execute one or more second instructions. In some example embodiments, from the fourth time point t4 to the sixth time point t6, the processing core block 220 may perform one or more second instructions of one or more second tasks.

From the fourth time point t4 to the sixth time point t6, the processing core block 220 may write an operation state or form of the processing core block 220 or at least a portion of data generated by a second operation on the second context. In some example embodiments, by referring to the entry pointer EP of the second context received at the fourth time point t4, the processing core block 220 may start the execution of the one or more second instructions included in each of one or more second tasks of each of one or more second threads.

Before (or immediately before) the fifth time point t5, the response handling block 230 may receive the response RES corresponding to the request REQ at the second time point t2. In some example embodiments, the response handling block 230 may write the response RES received at the fifth time point t5 or information about the response RES on the first context. For example, the response handling block 230 may write the received response RES on the target register which the first thread at the second time point t2 indicates. In some example embodiments, the response handling block 230 may transmit and/or send the first context, on which the response RES or the information about the response RES is written, to the context managing block 210 (or the response handling block 230 may update the first context and may wait without a separate operation).

At the sixth time point t6, the processing core block 220 may execute an instruction of the one or more second instructions indicating that at least portion of the second operation has a longer latency than the threshold value. For example, at the sixth time point t6, the processing core block 220 may perform the data request REQ being a portion of the data load operation having a longer latency than the threshold value. At the sixth time point t6, the processing core block 220 may write information of the lastly executed instruction of the one or more second instructions (e.g., the operation code opcode or the target register) on the second context. In some example embodiments, at the sixth time point t6, the processing core block 220 may write information of a next instruction (e.g., a subsequent instruction of the one or more second instructions) of the lastly executed instruction on the second context. For example, the processing core block 220 may change and/or update the entry pointer EP of the second context to an address and/or a pointer of the next instruction of the lastly executed instruction.

From the sixth time point t6 to an eighth time point t8, the processing core block 220 may perform context switching. For example, at the sixth time point t6, the processing core block 220 may transmit and/or send the second context to the response handling block 230; at a seventh time point t7, the response handling block 230 may receive the second context and may start to wait for the response RES to the request REQ at the sixth time point t6. The response handling block 230 may perform the response (RES) waiting and processing operation until a ninth time point t9.

Before (or immediately before) the eighth time point t8, the processing core block 220 may receive the first context. From the eighth time point t8 to a tenth time point t10, the processing core block 220 may execute the one or more first instructions. In some example embodiments, from the eighth time point t8 to the tenth time point t10, the processing core block 220 may perform a task following the task performed at the second time point t2 or any other task, may execute a thread different from the thread executed at the second time point t2, or may execute an instruction scheduled (subsequent in the same task) after the instruction of the one or more first instructions executed at the second time point t2 or any other instruction. In some example embodiments, from the fourth time point t4 to the sixth time point t6, the processing core block 220 may perform one or more second instructions of one or more second tasks.

From the eighth time point t8 to the tenth time point t10, the processing core block 220 may write an operation state or form of the processing core block 220 or at least portion of data generated by the first operation on the first context. In some example embodiments, by referring to the entry pointer EP of the second context received at the fourth time point t4, the processing core block 220 may start the execution of instructions included in each of one or more tasks of each of one or more threads.

Before (or immediately before) the ninth time point t9, the response handling block 230 may receive the response RES corresponding to the request REQ at the sixth time point t6. In some example embodiments, the response handling block 230 may write the response RES received at the ninth time point t9 or information about the response RES on the second context. For example, the response handling block 230 may write the received response RES on the target register which the thread at the sixth time point t6 indicates. In some example embodiments, the response handling block 230 may transmit and/or send the second context, on which the response RES or the information about the response RES is written, to the context managing block 210 (or the response handling block 230 may update the second context and may wait without a separate operation).

At the tenth time point t10, the processing core block 220 may perform context switching. In some example embodiments, at the tenth time point t10, under control of the operating system, the processing core block 220 may perform context switching and may not transmit and/or send the switched first context to the response handling block 230. Until the first operation is terminated after the context switching from the second context to the first context is completed, the processing core block 220 may execute one or more first instructions of one or more first operations of one or more first threads. After the tenth time point t10, at an arbitrary time point, the processing core block 220 may receive the second context and may write a form or information of the second operation or at least a portion of data generated by the second operation on the second context. In some example embodiments, until the second operation is terminated after the context switching from the first context to the received second context is completed, the processing core block 220 may perform a task following the task performed at the sixth time point t6 or any other task, may execute a thread different from the thread executed at the sixth time point t6, or may execute an instruction scheduled (subsequent in the same task) after the instruction of the one or more second instructions executed at the sixth time point t6 or any other instruction.

The operation of the processing core block 220 and/or the operation of the response handling block 230 described with reference to FIG. 6 are provided as an example, and the scope of the present inventive concepts are not limited thereto. The respective time points of FIG. 6 are intended to indicate the order of operations, and it should be understood that a time period between time points does not correspond to an actual time. It should be understood that some example embodiments in which the order of the respective time points of FIG. 6 are changed also belongs to the scope of the present inventive concepts. In FIG. 6, the description is given based on the example in which the processing core block 220 and/or the response handling block 230 performs one or more operations simultaneously at each time point, but the scope of the present inventive concepts are not limited thereto. It should be understood that a plurality of operations described at each time point and before and after each time point are performed sequentially or in parallel also belongs to the scope of the present inventive concepts. For example, unlike the example illustrated in FIG. 6 from the second time point t2 to the fourth time point t4, it should be understood that some example embodiments in which a time point at which a context switching operation is completed precedes a time point at which the response handling block 230 starts to wait for the response RES also belongs to the scope of the present inventive concepts. The number of operations each having a longer latency than the threshold value, which are described with reference to FIG. 6, is provided as an example, and the scope of the present inventive concepts not limited thereto.

According to some example embodiments, the processor 200 described with reference to FIGS. 3 to 6 may improve the efficiency of operation by performing any other task while waiting for an operation having a long latency. In some example embodiments, the processor 200 may improve the efficiency of operation by removing a data hazard and/or a stall which is capable of occurring during the pipe line operation. In some example embodiments, as the processor 200 loads data stored at a random location, the processor 200 may improve the efficiency of all operations by performing any other process during a response time to a data request when a long latency occurs. The processor 200 described with reference to FIGS. 3 to 6 is described based on a single core processor, and some example embodiments of a multi-core processor will be described in detail later.

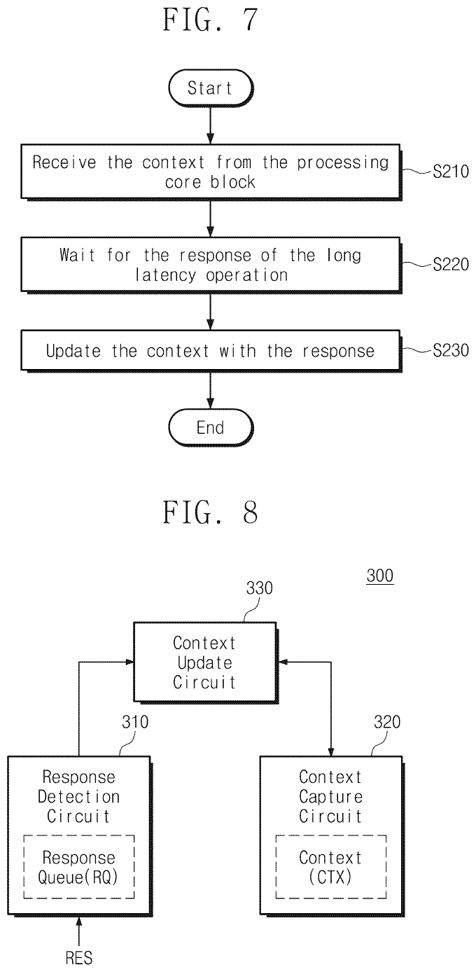

FIG. 7 is a flowchart illustrating an example of an operation method of a response handling block of FIG. 3, according to some example embodiments. The operation method of a response handling block according to some example embodiments of the present inventive concepts will be described with reference to FIGS. 3 to 7.

In operation S210, the response handling block 230 may receive a context from the processing core block 220. In some example embodiments, the response handling block 230 may receive a switched context. For example, the response handling block 230 may receive the switched context after the processing core block 220 executes an instruction indicating at least portion of an operation having a longer latency than the threshold value.

In some example embodiments, the context which the response handling block 230 receives may include information of a processor core block managing the context and information of the lastly executed instruction. For example, the context which the response handling block 230 receives may include the special function register SFR which includes the processor ID PID of the processing core block 220 managing the context or information of an instruction which the processing core block 220 lastly executes or information of an operation corresponding to the lastly executed instruction.

In operation S220, the response handling block 230 may wait for the response RES corresponding to the operation having the longer latency than the threshold value. In some example embodiments, the response handling block 230 may wait for the response RES corresponding to the instruction which is included in the received context and indicates the portion of the operation having the longer latency than the received threshold value. For example, the response handling block 230 may wait for the response RES corresponding to the request REQ generated by the execution of the instruction which the processing core block 220 lastly executes.

In operation S230, the response handling block 230 may update the context, based on the response RES. In some example embodiments, between operation S220 and operation S230, the response handling block 230 may receive the response RES.

In some example embodiments, the response handling block 230 may update the context, based on the response RES corresponding to the operation having the longer latency than the threshold value. In some example embodiments, the response handling block 230 may manage, update, and/or align the context, based on the received response RES. For example, the response handling block 230 may update the context, based on an operation of writing the response RES on the context. For example, the response handling block 230 may write the response RES on the target register by referring to the special function register SFR of the context CTX.

In some example embodiments, in operation S230, the response handling block 230 may write information about the response RES on the context. For example, when an error occurs in data included in the response RES, the response handling block 230 may write information indicating that the error occurred in the data, on the special function register SFR of the context CTX. In some example embodiments, the error of the response RES recorded at the context CTX may be corrected by an error correction block (not illustrated) which may be included in the processing core block 220 or the processor 200 and corrects the error of the data. In some example embodiments, the response handling block 230 may perform the remaining portion or all of the operation having the longer latency than the threshold value, based on operation S230. For example, the response handling block 230 may complete an operation of loading data to the target register, based on an operation of writing the received response RES in the target register on the context.

After operation S230, the response handling block 230 may transmit and/or send the (updated) context to the context managing block 210 or the processing core block 220. In some example embodiments, when the context is received, the processing core block 220 may perform one or more next tasks by referring to the entry pointer EP in the context. In some example embodiments, while the response handling block 230 performs the operation of FIG. 7, the processing core block 220 may perform any other task. For example, while the response handling block 230 receives the first context and performs the operation of FIG. 7, the processing core block 220 may write a form or information of another operation and at least portion of data generated by the other operation on the second context and may perform one or more tasks.

In FIG. 7, the description is given based on the example in which the response handling block 230 receives one context and changes, updates, and/or aligns the received context, but example embodiments are not limited thereto. It should be understood that some example embodiments in which the response handling block 230 manages, changes, updates, and/or aligns a plurality of contexts in parallel or sequentially based on the method described with reference to FIG. 7 also belongs to the scope of the present inventive concepts. In FIG. 7, the description is given based on the example in which the response handling block 230 receives a context from one processing core block (e.g., processing core block 220) and manages a response, but it should be understood that some example embodiments in which the response handling block 230 receives a context from a plurality of processing core blocks to be described later and manages one or more responses also belongs to the scope of the present inventive concepts. The operations described with reference to FIG. 7 are provided as an example, and it should be understood that some example embodiments in which at least some of the operations are performed to overlap each other and/or the order of some of the operations is changed also belongs to the scope of the present inventive concepts.

FIG. 8 is a block diagram illustrating an example of a response handling block of FIG. 3, according to some example embodiments. The response handling block 300 may correspond to the response handling block 230 of FIG. 3.

Referring to FIG. 8, the response handling block 300 may include a response detection circuit 310, a context capture circuit 320, and a context update circuit 330. The response handling block 300 according to some example embodiments of the present inventive concepts will be described with reference to FIGS. 3 to 8.

The response detection circuit 310 may detect the response RES input to the processor 200. In some example embodiments, the response detection circuit 310 may detect and manage the response RES, based on a response queue RQ. For example, the response detection circuit 310 may receive one or more responses RES and may store the one or more responses RES in the response queue RQ. The response detection circuit 310 may perform a response (RES) receiving operation between operation S220 and operation S230 of FIG. 7.

That the response detection circuit 310 manages the one or more responses RES by using the response queue RQ according to some example embodiments is provided as an example, and it should be understood that some example embodiments in which the response detection circuit 310 manages one or more responses RES based on various data structures such as a stack, a priority queue, and/or a tree also belongs to the scope of the present inventive concepts. The response detection circuit 310 may provide the received or stored response(s) RES to the context update circuit 330. For example, the response detection circuit 310 may transmit and/or send the one or more responses RES to the context update circuit 330 in the order in which the one or more responses RES are input to the response queue RQ.

The context capture circuit 320 may store the received context CTX. In some example embodiments, the context capture circuit 320 may capture one or more contexts CTX received from the processing core block 220. In some example embodiments, the context capture circuit 320 may store the received one or more contexts. The context capture circuit 320 may exchange the context CTX with the context update circuit 330.

The context update circuit 330 may update the context CTX. In some example embodiments, the context update circuit 330 may update the context CTX by writing the response RES in the corresponding context CTX. For example, the context update circuit 330 may update the context by writing one response RES in the response queue RQ on the corresponding context. In some example embodiments, the context update circuit 330 may select a processing core block (e.g., processing core block 220) to which the context will be transmitted and/or sent. For example, the context update circuit 330 may select a processing core block (e.g., processing core block 220) to which the context will be transmitted and/or sent, based on updating the processor ID PID in the context.

In some example embodiments, the context update circuit 330 may write information about the response RES on the context. For example, the context update circuit 330 may write information of the response RES including error information of data included in the response RES on the context (e.g., in the special function register SFR of the context). In some example embodiments, the context update circuit 330 may transmit and/or send the updated context CTX to the processing core block 220 or the context managing block 210. For example, the context update circuit 330 may transmit and/or send the updated context to the context managing block 210 (e.g., through the context capture circuit 320). The context update circuit 330 may perform an operation(s) identical or similar to an operation(s) performed in operation S330 of FIG. 7.

In FIG. 8, the description is given based on an example embodiment in which the context update circuit 330 updates one context CTX, based on the response RES, but example embodiments are not limited thereto. It should be understood that some example embodiments in which the context update circuit 330 updates and manages a plurality of contexts sequentially in parallel or some example embodiments in which the context update circuit 330 sequentially updates the plurality of contexts each corresponding to the response RES depending on the order in which the response RES is received also belongs to the scope of the present inventive concepts. FIG. 8 describes an example in which the context update circuit 330 changes and/or updates the processor ID PID, but example embodiments are not limited thereto. For example, it should be understood that some example embodiments in which the context update circuit 330 and/or the processing core block 220 changes the processor ID PID also belongs to the scope of the present inventive concepts.

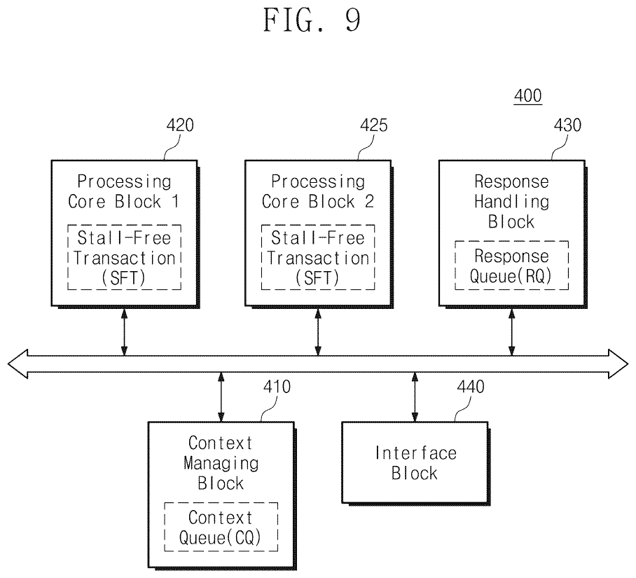

FIG. 9 is a block diagram illustrating a processor of FIG. 1, according to some example embodiments. The processor 400 may correspond to the processor 100 of FIG. 1.

Referring to FIG. 9, the processor 400 may include a context managing block 410, a first processing core block 420, a second processing core block 425, a response handling block 430, and an interface block 440. The processor 400 having a multi-core according to some example embodiments of the present inventive concepts will be described in with reference to FIGS. 1 to 9.

The context managing block 410 may manage a context to be provided to the first processing core block 420 and the second processing core block 425. For example, the context managing block 410 may manage one or more first contexts to be provided to the first processing core block 420 and one or more second contexts to be provided to the second processing core block 425. The context managing block 410 may be identical and/or similar to the context managing block 210 of FIG. 3, and an operation of the context managing block 410 may be identical and/or similar to the operation of the context managing block 210 of FIG. 3. In some example embodiments, the context managing block 410 may include the context queue CQ which stores one or more contexts.

The first processing core block 420 and the second processing core block 425 may execute one or more instructions. For example, each of the first processing core block 420 and the second processing core block 425 may execute one or more instructions to control an operation of the processor 400 and/or to perform a process. In some example embodiments, the first processing core block 420 and the second processing core block 425 may execute one or more instructions to perform a task including one or more instructions. In some example embodiments, the first processing core block 420 and the second processing core block 425 may execute a thread including one or more tasks, based on performing the or more tasks.

In some example embodiments, the first processing core block 420 and the second processing core block 425 may execute a plurality of instructions in parallel (e.g., simultaneously). In some example embodiments, each of the first processing core block 420 and the second processing core block 425 may execute at least some of a plurality of instructions based on the pipe line operation, so as to overlap each other. For example, each of the first processing core block 420 and the second processing core block 425 may execute at least some of a plurality of instructions based on two or more pipe line operations being parallel, simultaneously or so as to overlap each other.

Each of the first processing core block 420 and the second processing core block 425 may be identical and/or similar to the processing core block 220 of FIGS. 3 to 6. An operation of each of the first processing core block 420 and the second processing core block 425 may be identical to and/or similar to the operation of the processing core block 220 described with reference to FIGS. 3 to 8. Each of the first processing core block 420 and the second processing core block 425 may support the stall-free transaction SFT of, e.g., FIG. 3.

In some example embodiments, each of the first processing core block 420 and the second processing core block 425 may have an identifier ID. For example, the first processing core block 420 may have a first ID, and the second processing core block 425 may have a second ID. In some example embodiments, the processor ID PID of the context CTX of FIG. 4 may point out the first processing core block 420 or the second processing core block 425. For example, when the processor ID PID of the first context has the first ID, the first context may be managed by the first processing core block 420 and/or may be provided to the first processing core block 420. Likewise, in some example embodiments, when the processor ID PID of the second context has the second ID, the second context may be managed by the second processing core block 425 and/or may be provided to the second processing core block 425.

The response handling block 430 may manage a response to a request which the first processing core block 420 and/or the second processing core block 425 issue. In some example embodiments, the response handling block 430 may manage one or more responses RES and/or one or more contexts corresponding thereto. In some example embodiments, the response handling block 430 may manage the received response RES and may change, align, and/or update the context, based on the response RES. For example, the response handling block 430 may write the response RES on the context and may update the processor ID PID (e.g., by designating a processing core block (e.g., the first processing core block 420 or the second processing core block 425) which will perform a thread).

The response handling block 430 may be identical and/or similar to the response handling block 230 described with reference to FIG. 3 or the response handling block 300 described with reference to FIG. 8. An operation of the response handling block 430 may be identical and/or similar to the operation of the response handling block 230 described with reference to FIG. 3 or the response handling block 300 described with reference to FIG. 8. The response handling block 430 may manage and/or store one or more responses RES, based on the response queue RQ. For example, the response handling block 430 may manage two or more contexts received from the first processing core block 420 and the second processing core block 425, and may receive two or more responses so as to be updated on the corresponding context.

The interface block 440 may perform data exchange between the processor 400 and an external device. For example, the interface block 440 may perform the data exchange between the processor 400 and the memory device 11 of FIG. 1. The interface block 440 may be identical and/or similar to the interface block 240 of FIG. 3, and an operation of the interface block 440 may be identical and/or similar to the operation of the interface block 240 of FIG. 3.

The blocks illustrated in FIG. 9 and operations of the blocks described with reference to FIG. 3 are provided as an example, but example embodiments are not limited thereto. It should be understood that some example embodiments in which the processor 400 includes an additional processing core block(s) also belongs to the scope of the present inventive concepts. According to some example embodiments, the blocks of FIG. 9 are distinguished based on functions, not physically distinguished from each other. It should be understood that some example embodiments in which functions of at least some of the blocks of FIG. 9 are performed by any other block also belongs to the scope of the present inventive concepts. It should be understood that some example embodiments which does not include at least some of the components illustrated in FIG. 9 and/or further includes another component also belongs to the scope of the present inventive concepts. For example, the processor 400 may further include a (local) cache memory block capable of storing an instruction, data, the context queue CQ, and/or the response queue RQ. That the context queue CQ and/or the response queue RQ has a queue structure according to some example embodiments is provided as an example, but example embodiments are not limited thereto. For example, it should be understood that some example embodiments in which the context queue CQ and/or the response queue RQ is implemented with a stack or a priority queue and/or in any other data structure also belongs to the scope of the present inventive concepts.

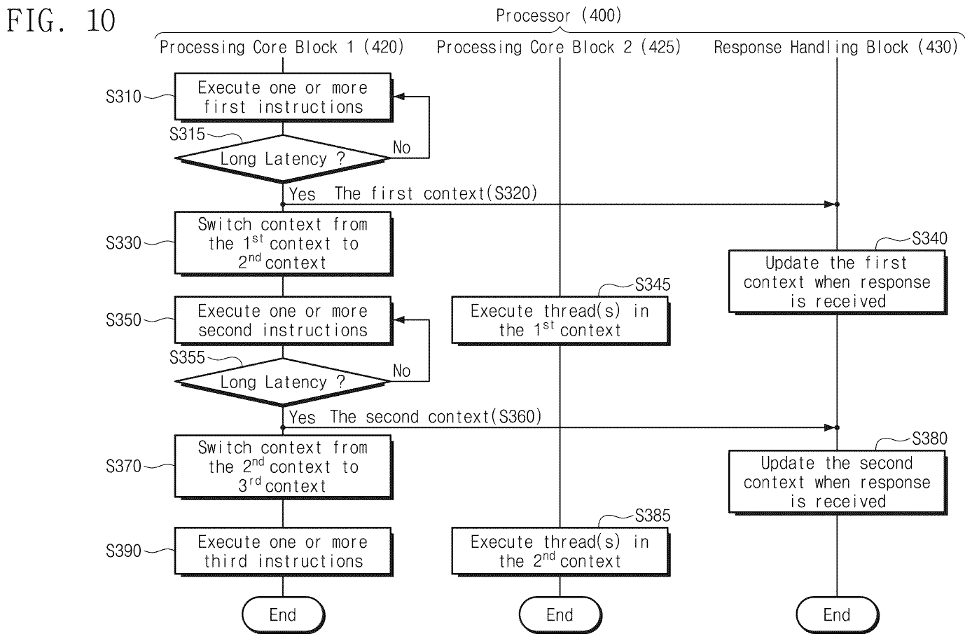

FIG. 10 is a flowchart illustrating an example of an operation method of a processor of FIG. 9, according to some example embodiments. The operation method of the processor 400 according to some example embodiments of the present inventive concepts will be described in detail with reference to FIGS. 1 to 10.

In operation S310, the first processing core block 420 may execute one or more first instructions. For example, the first processing core block 420 may perform or execute one or more first tasks and/or one or more first threads, based on executing one or more first instructions. In some example embodiments, in operation S310, the first processing core block 420 may write an operation form or state of the first processing core block 420 and/or at least portion of data generated by a first operation on the first context. In some example embodiments, the first processing core block 420 may start the execution of the one or more first instructions by referring to an entry pointer EP of a first context. The first processing core block 420 may perform operation S310 to be identical and/or similar to operation S110 and/or operation S140 of FIG. 5.

In operation S315, the first processing core block 420 may determine a next progress operation, based on whether the lastly executed instruction of the one or more first instructions indicates that at least a portion of the first operation has a longer latency than the threshold value. For example, when the lastly executed instruction of the one or more first instructions indicates at least a portion of the first operation as having the longer latency than the threshold value, “Yes” in operation S315, the first processing core block 420 may proceed to operation S320. For example, when the lastly executed instruction of the one or more first instructions does not indicate at least a portion of the first operation as having the longer latency than the threshold value, “No” in operation S315, the first processing core block 420 may again return to operation S310. The first processing core block 420 may perform operation S315 to be identical and/or similar to operation S120 and/or operation S150 of FIG. 5.

In operation S320, the first processing core block 420 may transmit and/or send the first context to the response handling block 430. In some example embodiments, the first processing core block 420 may write (e.g., prior to transmitting and/or sending the first context to the response handling block 430), on the first context, information about the lastly executed instruction of the one or more first instructions, information of all of the first operation indicated by the lastly executed instruction of the one or more first instructions or the portion of the first operation indicated by the lastly executed instruction of the one or more first instructions, and/or information of an instruction (e.g., an address or a pointer of an instruction) to be next performed. For example, when the lastly executed instruction of the one or more first instructions indicates a portion of the data load operation (e.g., as the portion of the first operation) as having a longer latency than the threshold value, the first processing core block 420 may transmit and/or send the first context including the information of the lastly executed instruction of the one or more first instructions or information of the target register to which data are loaded to the response handling block 430. The first processing core block 420 may perform operation S320 to be identical and/or similar to the operation of transmitting and/or sending the context to a response handling block of a processing core block described with reference to FIGS. 3 to 6 and 9.

In operation S330, the first processing core block 420 may perform context switching from the first context to a second context. The first processing core block 420 may perform operation S330 to be identical and/or similar to the context switching operation of the processing core block described with reference to FIGS. 3 to 6 and 9.

In operation S340, the response handling block 430 may update the first context when the response is received. In some example embodiments, by referring to the first context, the response handling block 430 may receive the response corresponding to (a request indicated by) the lastly executed instruction of the one or more first instructions recorded at the first context and may update the first context. For example, the response handling block 430 may receive the response corresponding to the lastly executed instruction of the one or more first instructions recorded at the first context and may write the received response on the first context, by referring to the first context, so as to coincide with the information written on the first context. For example, the response handling block 430 may write the received response on the target register depending on the information written on the first context.

The response handling block 430 may perform operation S340 to be identical and/or similar to the response receiving operation and/or the context update operation described with reference to FIGS. 3 to 9. For example, the response handling block 430 may perform operation S340 to be identical or similar to the operation of FIG. 7. In some example embodiments, the response handling block 430 may maintain or update the processor ID PID of the first context. For example, the response handling block 430 may maintain the processor ID PID of the first context as the first ID of the first processing core block 420. In some example embodiments, the response handling block 430 may change the processor ID PID of the first context to the second ID of the second processing core block 425.

According to some example embodiments, after the response handling block 430 completes operation S340, the response handling block 430 may transmit and/or send the updated first context to the context managing block 410 or to one of the first processing core block 420 or the second processing core block 425. For example, the response handling block 430 may transmit and/or send the first context to the second processing core block 425, depending on that the processor ID PID of the first context is the second ID. In some example embodiments, the response handling block 430 may transmit and/or send the (updated) first context to the context queue CQ of the context managing block 410. Below, the description will be given based on an example in which the response handling block 430 transmits and/or sends the first context to the second processing core block 425, but example embodiments are not limited thereto.

In operation S345, the second processing core block 425 may execute the one or more first instructions to execute, for example, a thread or threads in the first context. For example, the second processing core block 425 may perform and/or execute the one or more first tasks and/or the one or more first threads, based on executing the one or more first instructions. In some example embodiments, the second processing core block 425 may write a form or information of the first operation or at least a portion of data generated by the first operation on the received first context. In some example embodiments, the second processing core block 425 may start the execution of the one or more first instructions by referring to the entry pointer EP of the updated first context. The second processing core block 425 may perform operation S345 to be identical and/or similar to the operation of the first processing core block 420 performed in operation S110 and/or operation S140 of FIG. 5 and/or in operation S310.

In operation S350, the first processing core block 420 may execute one or more second instructions. For example, the first processing core block 420 may perform and/or execute one or more second tasks and/or one or more second threads, based on executing the one or more second instructions. In some example embodiments, the first processing core block 420 may write a form or information of a second operation or at least portion of data generated by the second operation on the second context. In some example embodiments, the first processing core block 420 may start the execution of the one or more second instructions by referring to an entry pointer EP of the received second context. The first processing core block 420 may perform operation S350 to be identical and/or similar to the operation of the second processing core block 425 performed in operation S110 and/or operation S140 of FIG. 5 and/or in operation S345.

In operation S355, the first processing core block 420 may determine a next progress operation, based on whether the lastly executed instruction of the one or more second instructions indicates at least a portion of the second operation as having a longer latency than the threshold value. For example, when the lastly executed instruction of the one or more second instructions indicates at least a portion of the second operation as having the longer latency than the threshold value, “Yes” in operation S355, the first processing core block 420 may proceed to operation S360. In some example embodiments, when the lastly executed instruction of the one or more second instructions does not indicate at least a portion of the second operation as having the longer latency than the threshold value, “No” in operation S355, the first processing core block 420 may again return to operation S350. The first processing core block 420 may perform operation S355 to be identical and/or similar to operation S120 and/or operation S150 of FIG. 5 and/or operation 315.

In operation S360, the first processing core block 420 may transmit and/or send the second context to the response handling block 430. In some example embodiments, the first processing core block 420 may write, on the second context, information about the lastly executed instruction of the one or more second instructions, information of all of the second operation indicated by the lastly executed instruction or the portion of the second operation indicated by the lastly executed instruction, and/or information of an instruction (e.g., an address or a pointer of an instruction) to be next performed. For example, when the lastly executed instruction of the one or more second instructions indicates a portion of the data load operation as having a longer latency than the threshold value, the first processing core block 420 may transmit and/or send the second context including the information of the lastly executed instruction or information of the target register to which data are loaded to the response handling block 430. The first processing core block 420 may perform operation S360 to be identical and/or similar to the operation of transmitting and/or sending the context to the response handling block of the processing core block described with reference to FIGS. 3 to 6 and 9 and/or operation S320.

In operation S370, the first processing core block 420 may perform context switching from the second context to a third context. The first processing core block 420 may perform operation S370 through an operation which is identical and/or similar to the context switching operation of the processing core block described with reference to FIGS. 3 to 6 and 9 and/or is identical and/or similar to the operation performed in operation S330.

In operation S380, the response handling block 430 may update the second context when the response is received. In some example embodiments, by referring to the second context, the response handling block 430 may receive a response corresponding to (a request indicated by) the instruction of the one or more second instructions recorded at the second context and may update the second context. For example, the response handling block 430 may receive a response corresponding to the lastly executed instruction of the one or more second instructions recorded at the second context and may write the received response on the second context, by referring to the second context, so as to coincide with the information written on the second context. For example, the response handling block 430 may write the received response on the target register depending on the information written on the second context.

The response handling block 430 may perform operation S380 to be identical and/or similar to the response receiving operation and/or the context update operation of the response handling block described with reference to FIGS. 3 to 9, or the operation performed in operation S340. For example, the response handling block 430 may perform operation S380 to be identical and/or similar to the operation of FIG. 7. In some example embodiments, the response handling block 430 may maintain or update the processor ID PID of the second context. For example, the response handling block 430 may maintain the processor ID PID of the second context as the first ID of the first processing core block 420. In some example embodiments, the response handling block 430 may change the processor ID PID of the second context to the second ID of the second processing core block 425.

According to some example embodiments, after the response handling block 430 completes operation S380, the response handling block 430 may transmit and/or send the updated second context to the context managing block 410 or one of the first processing core block 420 or the second processing core block 425. For example, the response handling block 430 may transmit and/or send the second context to the second processing core block 425, depending on that the processor ID PID of the second context is the second ID. In some example embodiments, the response handling block 430 may transmit and/or send the (updated) second context to the context queue CQ of the context managing block 410. Below, the description will be given based on an example in which the response handling block 430 transmits and/or sends the second context to the second processing core block 425, but example embodiments are not limited thereto.

In operation S385, the second processing core block 425 may execute one or more instructions to execute, for example, a thread or threads in the second context. For example, the second processing core block 425 may perform or execute the one or more second tasks or the one or more second threads, based on executing the one or more second instructions. In some example embodiments, the second processing core block 425 may write a form or information of the second operation or at least portion of data generated by the second operation on the received second context. In some example embodiments, the second processing core block 425 may start the execution of the one or more second instructions by referring to the entry pointer EP of the updated second context. The first processing core block 420 may perform operation S390 to be identical or similar to the operation of the second processing core block 425 performed in operation S110 or operation S140 of FIG. 5 or in operation S310, operation S345, or operation S385.

In operation S390, the first processing core block 420 may execute one or third more instructions. For example, the first processing core block 420 may perform and/or execute one or more third tasks and/or one or more third threads, based on executing one or more third instructions. In some example embodiments, the first processing core block 420 may write a form or information of a third operation or at least portion of data generated by the third operation on the third context. In some example embodiments, the first processing core block 420 may start the execution of the one or more third instructions by referring to the entry pointer EP of the received third context. The first processing core block 420 may perform operation S390 to be identical and/or similar to the operation of the second processing core block 425 performed in operation S110 and/or operation S140 of FIG. 5 or in operation S310, operation S345, or operation S385.

The operation method of the processor 400 described with reference to FIG. 10 is provided as an example, but example embodiments are not limited thereto. For example, in FIG. 10, the description is given based on an example in which only the first processing core block 420 executes an instruction indicating a portion of an operation having a longer latency than the threshold value and performs context switching, but it should be understood that, in some example embodiments, the second processing core block 425 may also perform the same operation as the first processing core block 420. For example, in FIG. 10, the description is given based on the example in which the processor 400 manages operation forms or information of the first processing core block 420 and the second processing core block 425 through the first to third contexts and stores at least portion of data used for the operation or generated by the operation, but it should be understood that some example embodiments in which the processor 400 executes instructions, performs a task, or executes a thread, by using four or more contexts also belongs to the scope of the present inventive concepts. For example, in FIG. 10, the description is given based on the example in which the second processing core block 425 does not perform a (e.g., processing) operation before operation S345, but example embodiments are not limited thereto. For example, it should be understood that some example embodiments in which the second processing core block 425 executes one or more threads by using any other context before operation S345 also belongs to the scope of the present inventive concepts. The description is given based on the example in which the first processing core block 420 and the second processing core block 425 perform context switching when the first processing core block 420 and the second processing core block 425 execute an instruction indicating all or portion of an operation having a longer latency than the threshold value, but example embodiments are not limited thereto. For example, it should be understood that some example embodiments in which the first processing core block 420 and the second processing core block 425 perform context switching depending on scheduling and/or a control signal also belongs to the scope of the present inventive concepts.

The operation described with reference to FIG. 10 is provided as an example, and example embodiments are not limited thereto. For example, it should be understood that some example embodiments in which the order of some of the above operations is changed or some example embodiments in which at least some of the above operations are performed to overlap each other also belongs to the scope of the present inventive concepts. According to some example embodiments, based on one or more operations described with reference to FIGS. 9 and 10, the processor 400 may efficiently manage a latency by utilizing one or more processing core blocks 420 and 425 and the response handling block 430 and may efficiently perform or execute one or more tasks and/or one or more threads more efficiently.

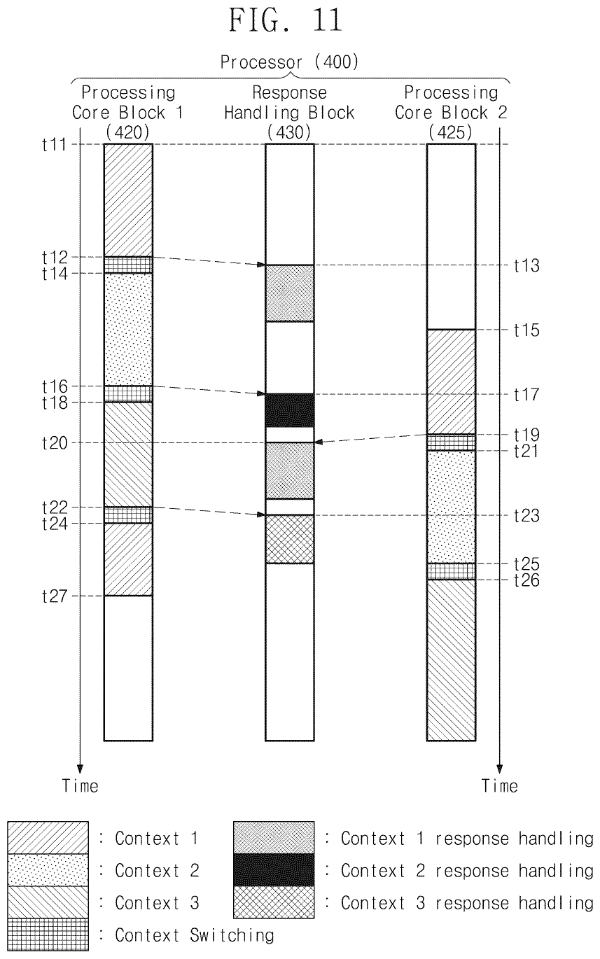

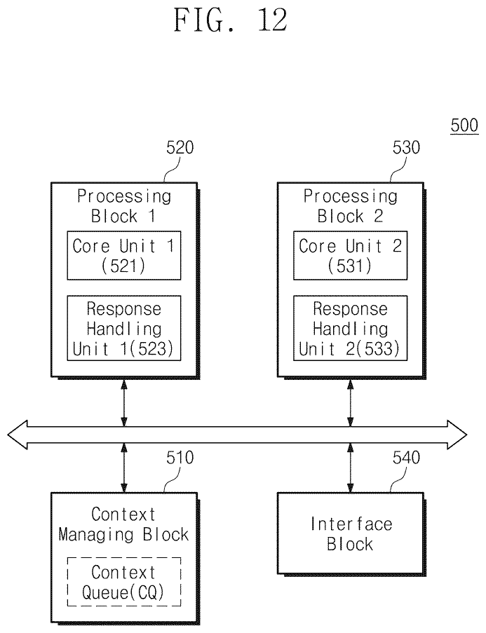

FIG. 11 is a diagram illustrating an example of an operation of a processor of FIG. 9 over time, according to some example embodiments. The operation of the processor 400 according to some example embodiments of the present inventive concepts will be described in detail with reference to FIGS. 1 to 11.

At a 11th first time point t11, the processor 400 may start a first operation. For example, at the 11th first time point t11, based on starting the execution of one or more first instructions, the first processing core block 420 may perform a first task and/or may execute a first thread. In some example embodiments, the first processing core block 420 may write an operation form or information on the first context or may store at least a portion of data utilized for the first operation or at least a portion of data generated by the first operation. For example, at the 11th first time point t11, the first processing core block 420 may start the execution of an instruction of the one or more first instructions by referring to the entry pointer EP of the first context. From the 11th first time point t11 to a 12th time point t12, the first processing core block 420 may execute the one or more first instructions.

In some example embodiments, an instruction of the one or more first instructions which the first processing core block 420 executes at the 12th time point t12 and/or immediately before the 12th time point t12 may indicate at least a portion of the first operation as having a longer latency than the threshold value. For example, the instruction of the one or more first instructions which the first processing core block 420 executes immediately before the 12th time point t12 may indicate the data request REQ as being a portion of the data load operation having the longer latency than the threshold value.

From the 12th time point t12 to a 14th time point t14, the first processing core block 420 may perform context switching. The first processing core block 420 may transmit and/or send the first context to the response handling block 430 at the 12th time point t12, and the response handling block 430 may receive the first context at a 13th time point t13. From the 13th time point t13, the response handling block 430 may wait for the response RES including data according to the data request REQ written in the first context. In some example embodiments, the switched first context may include information of the lastly executed instruction of the one or more first instructions, information of all or a portion of the first operation indicated by the lastly executed instruction, and/or information of an instruction (e.g., an address and/or a pointer of an instruction) to be next performed. Before the 14th time point t14, the first processing core block 420 may receive the second context.

From the 13th time point t13 to an arbitrary time point before a 15th time point t15, the response handling block 430 may perform the operation described with reference to FIG. 7. For example, the response handling block 430 may update the first context by recording the received response RES on the first context. Simultaneously, the response handling block 430 may change the processor ID PID of the first context to the second ID of the second processing core block 425 such that the first context is transmitted and/or sent to the second processing core block 425. In some example embodiments, the response handling block 430 may complete the first operation which the instruction executed by the first processing core block 420 indicates. For example, the response handling block 430 may complete the data load operation by writing the data included in the response RES on the target register in the first context.

At the 14th time point t14, the first processing core block 420 may complete context switching. From the 14th time point t14 to a 16th time point t16, the first processing core block 420 may write an operation form or information of the first processing core block 420 or at least portion of data used for a second operation, or at least portion of data generated by the second operation on the second context. For example, at the 14th time point t14, the first processing core block 420 may start the execution of an instruction of one or more second instructions by referring to an entry pointer EP of the second context. From the 14th time point t14 to the 16th time point t16, the first processing core block 420 may execute the one or more second instructions.

Before the 15th time point t15, the second processing core block 425 may receive the first context from the response handling block 430. From the 15th time point t15 to a 19th time point t19, the second processing core block 425 may execute the one or more first instructions and may perform the one or more first tasks and/or may execute the one or more first threads, based on executing the one or more first instructions. In some example embodiments, the second processing core block 425 may write an operation form or information on the first context or may store at least portion of data used for the first operation or at least portion of data generated by the first operation. For example, at the 15th time point t15, the second processing core block 425 may start the execution of an instruction of the one or more first instructions by referring to the entry pointer EP of the first context.

From the 16th time point t16 to a 18th time point t18, the first processing core block 420 may perform context switching. The first processing core block 420 may transmit and/or send the second context to the response handling block 430 at the 16th time point t16, and the response handling block 430 may receive the second context at a 17th time point t17. From the 17th time point t17, the response handling block 430 may wait for the response RES including data according to the data request REQ written in the second context. In some example embodiments, the switched second context may include information of the lastly executed instruction of the one or more second instructions, information of all or a portion of the second operation indicated by the lastly executed instruction of the one or more send instructions, and/or information of an instruction (e.g., an address and/or a pointer of an instruction) to be next performed. Before the 18th time point t18, the first processing core block 420 may receive a third context.

From the 17th time point t17 to an arbitrary time point before a 19th time point t19, the response handling block 430 may perform the operation described with reference to FIG. 7. For example, the response handling block 430 may update the second context by recording the received response RES on the second context. Simultaneously, the response handling block 430 may change the processor ID PID of the second context to the second ID of the second processing core block 425 such that the second context is transmitted and/or sent to the second processing core block 425. In some example embodiments, the response handling block 430 may complete the second operation which the instruction executed by the first processing core block 420 indicates in the second context. For example, the response handling block 430 may complete the data load operation by writing data included in the response RES on the target register in the second context.

At the 18th time point t18, the first processing core block 420 may complete context switching. From the 18th time point t18 to a 22nd time point t22, the first processing core block 420 may write an operation form or information of the first processing core block 420, at least portion of data necessary for a third operation, or at least portion of data generated by the third operation on the third context. For example, at the 18th time point t18, the first processing core block 420 may start the execution of an instruction of one or more third instructions by referring to an entry pointer EP of the third context. From the 18th time point t18 to the 22nd time point t22, the first processing core block 420 may execute the one or more third instructions.

From the 19th time point t19 to a 21st time point t21, the second processing core block 425 may perform context switching. The second processing core block 425 may transmit and/or send the first context to the response handling block 430 at the 19th time point t19, and the response handling block 430 may receive the first context at a 20th time point t20. From the 20th time point t20, the response handling block 430 may wait for the response RES including data according to the data request REQ written in the first context. In some example embodiments, the switched first context may include information of the lastly executed instruction of the one or more first instructions, information of all or portion of the first operation indicated by the lastly executed instruction, and/or information of an instruction (e.g., an address and/or a pointer of an instruction) to be next performed. Before the 21st time point t21, the second processing core block 425 may receive the second context.

From the 20th time point t20 to an arbitrary time point before the 22nd time point t22, the response handling block 430 may perform the operation described with reference to FIG. 7. For example, the response handling block 430 may update the first context by recording the received response RES on the first context. Simultaneously, the response handling block 430 may change the processor ID PID of the first context to the first ID of the first processing core block 420 such that the first context is transmitted and/or sent to the first processing core block 420. In some example embodiments, the response handling block 430 may complete the first operation which the instruction executed by the first processing core block 420 indicates. For example, the response handling block 430 may complete the data load operation by writing the data included in the response RES on the target register in the first context.

At the 21st time point t21, the second processing core block 425 may complete context switching. From the 21st time point t21 to a 25th time point t25, the second processing core block 425 may write an operation form or information of the second processing core block 425, at least portion of data necessary for the second operation, or at least portion of data generated by the second operation on the second context. For example, at the 21st time point t21, the second processing core block 425 may start the execution of an instruction of the one or more second instructions by referring to the entry pointer EP of the second context. From the 21st time point t21 to the 25th time point t25, the second processing core block 425 may execute the one or more second instructions.

From the 22nd time point t22 to a 24th time point t24, the first processing core block 420 may perform context switching. The first processing core block 420 may transmit and/or send the third context to the response handling block 430 at the 22nd time point t22, and the response handling block 430 may receive the third context at a 23rd time point t23. From the 23rd time point t23, the response handling block 430 may wait for the response RES including data according to the data request REQ written in the third context. In some example embodiments, the switched third context may include information of the lastly executed instruction of one or more third instructions, information of all or portion of the third operation indicated by the lastly executed instruction, information of an instruction (e.g., an address and/or a pointer of an instruction) to be next performed. Before the 24th time point t24, the first processing core block 420 may receive the first context.

From the 23rd time point t23 to an arbitrary time point before the 26th time point t26, the response handling block 430 may perform the operation described with reference to FIG. 7. For example, the response handling block 430 may update the third context by recording the received response RES on the third context. Simultaneously, the response handling block 430 may change the processor ID PID of the third context to the second ID of the second processing core block 425 such that the third context is transmitted and/or sent to the second processing core block 425. In some example embodiments, the response handling block 430 may complete the third operation which the instruction executed by the second processing core block 425 indicates. For example, the response handling block 430 may complete the data load operation by writing the data included in the response RES on the target register in the third context.

At the 24th time point t24, the first processing core block 420 may complete context switching. From the 24th time point t24 to a 27th time point t27, the first processing core block 420 may write an operation form or information of the first processing core block 420, at least portion of data necessary for the first operation, or at least portion of data generated by the first operation on the first context. For example, at the 24th time point t24, the first processing core block 420 may start the execution of an instruction by referring to the entry pointer EP of the third context. From the 24th time point t24 to the 27th time point t27, the first processing core block 420 may execute one or more instructions.

From a 25th time point t25 to a 26th time point t26, the second processing core block 425 may perform context switching. For example, from the 25th time point t25 to the 26th time point t26, the second processing core block 425 may perform context switching from the second context to the third context. In some example embodiments, from the 25th time point t25 to the 26th time point t26, the second processing core block 425 may perform context switching depending on scheduling. Because the second processing core block 425 does not perform context switching depending on that a portion of an operation having a longer latency than the threshold value is indicated, the second processing core block 425 may not transmit and/or send the second context to the response handling block 430.

At the 26th time point t26, the second processing core block 425 may complete context switching and may write an operation form or information on the third context. In some example embodiments, at the 26th time point t26, the second processing core block 425 may start the execution of an instruction by referring to the entry pointer EP of the third context.

The operation form of the processor 400 described with reference to FIG. 11 is provided as an example, and the scope of the present inventive concepts should be not limited to the illustration and description of FIG. 11. The description is given based on the example in which the second processing core block 425 does not perform an operation before the 15th time point t15, but it should be understood that some example embodiments in which the second processing core block 425 writes the operation form or information through any other context before the 15th time point t15 and stores at least portion of data utilized for the operation or at least portion of data generated by the operation also belongs to the scope of the present inventive concepts.

In FIG. 11, the description is given based on some example embodiments in which the response handling block 430 waits for a response to only one response and updates the context depending on the response, but it should be understood that some example embodiments in which the response handling block 430 waits for responses respectively corresponding to a plurality of contexts and updates the plurality of contexts depending on the responses also belongs to the scope of the present inventive concepts. In FIG. 11, the description is given based on some example embodiments in which the processor 400 performs processing by utilizing three contexts, and this is provided as an example. For example, it should be understood that some example embodiments in which the processor 400 operates by utilizing an additional context also belongs to the scope of the present inventive concepts. In FIG. 11, the description is given based on the example of the processing of two processing core blocks, but it should be understood that some example embodiments in which the operation of the present inventive concepts is implemented by using additional processing core blocks further provided also belongs to the scope of the present inventive concepts.

The respective time points of FIG. 11 are intended to indicate the order of operations, and it should be understood that a time period between time points does not correspond to an actual time. It should be understood that some example embodiments in which the order of the respective time points of FIG. 11 is changed also belongs to the scope of the present inventive concepts. In FIG. 11, the description is given based on the example in which the first processing core block 420 and the second processing core block 425 and/or the response handling block 230 performs one or more operations simultaneously at each time point, but the scope of the present inventive concepts are not limited thereto. It should be understood that a plurality of operations described at each time point and before and after each time point are performed sequentially and/or in parallel also belongs to the scope of the present inventive concepts. For example, unlike the example illustrated in FIG. 11 from the 12th time point t12 to the 14th time point t14, it should be understood that some example embodiments in which a time point at which a context switching operation is completed precedes a time point at which the response handling block 430 starts to wait for the response RES also belongs to the scope of the present inventive concepts. The number of operations each having a longer latency than the threshold value, which are described with reference to FIG. 11, is provided as an example, and the scope of the present inventive concepts are not limited thereto.

The processor 400 described with reference to FIGS. 9 to 11 may improve the efficiency of operation by performing any other task and/or executing any other thread while waiting for an operation having a long latency. The processor 400 may improve the efficiency of operation by removing a data hazard and/or a stall which is capable of occurring during the pipe line operation. For example, as the processor 400 loads data stored at a random location, the processor 400 may improve the efficiency of all operations by performing any other task or a process of a thread during a response time to a data request when a long latency occurs.

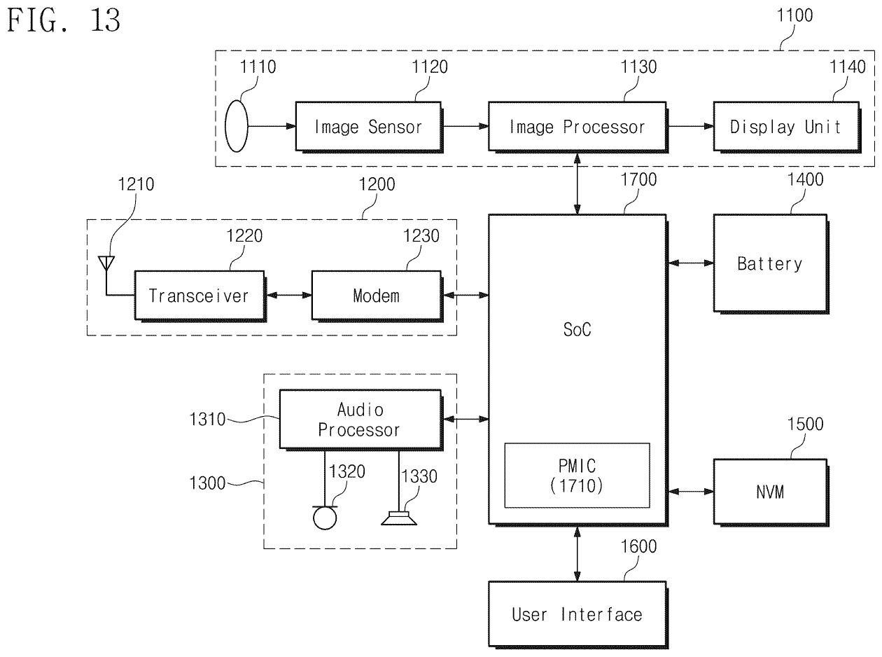

FIG. 12 is a block diagram illustrating an example of a processor of FIG. 1, according to some example embodiments. The processor 500 may correspond to the processor 100 of FIG. 1. Referring to FIG. 12, the processor 500 may include a context managing block 510, a first processing block 520, a second processing block 530, and an interface block 540. The processor 500 according to some example embodiments of the present inventive concepts will be described with reference to FIGS. 1 to 12.

The context managing block 510 may manage a context which the first processing block 520 and the second processing block 530 will perform. In some example embodiments, the context managing block 510 may manage one or more contexts, based on the context queue CQ. The context managing block 510 may be identical and/or similar to the context managing block 210 of FIGS. 3 to 6 or the context managing block 410 of FIGS. 9 to 11, and an operation of the context managing block 510 may be identical and/or similar to the operation of the context managing block 210 or 410.

The first processing block 520 and the second processing block 530 may perform a process of the processor 500. In some example embodiments, the first processing block 520 may include a first core unit 521 and a first response handling unit 523, and the second processing block 530 may include a second core unit 531 and a second response handling unit 533. For example, the first processing block 520 may include the first core unit 521 and the first response handling unit 523, and the second processing block 530 may include the second core unit 531 and the second response handling unit 533.

An operation of each of the first core unit 521 and the second core unit 531 may be identical and/or similar to the operation of the processing core block 220 of FIGS. 3 to 6 or the operation of each of the first processing core block 420 and the second processing core block 425 of FIGS. 9 to 11. An operation of each of the first response handling unit 523 and the second response handling unit 533 may be identical and/or similar to the operation of the response handling block 230 of FIGS. 3 to 7, the operation of the response handling unit 300 of FIG. 8, or the operation of the response handling block 430 of FIGS. 9 to 11.

The interface block 540 may perform data exchange between the processor 500 and the external device. For example, the interface block 540 may perform the data exchange between the processor 500 and the memory device 11 of FIG. 1. The interface block 540 may be identical and/or similar to the interface block 240 of FIG. 3 or the interface block 440 of FIG. 9, and an operation of the interface block 540 may be identical and/or similar to the operation of the interface block 240 of FIG. 3 or the operation of the interface block 440 of FIG. 9.

The blocks illustrated in FIG. 12 and operations of the blocks described with reference to FIG. 3 are provided as an example, and the scope of the present inventive concepts are not limited thereto. It should be understood that some example embodiments in which the processor 500 includes an additional processing block(s) also belongs to the scope of the present inventive concepts. The processing block of FIG. 12 is provided as an example, and it should be understood that some example embodiments in which each of the first processing block 520 and the second processing block 530 further includes a context managing unit configured to perform the function of the context managing block 510 also belongs to the scope of the present inventive concepts. The blocks of FIG. 12 are distinguished based on functions, not physically distinguished from each other. It should be understood that some example embodiments in which functions of at least some of the blocks of FIG. 9 are performed by any other block also belongs to the scope of the present inventive concepts. It should be understood that some example embodiments which does not include at least some of the components illustrated in FIG. 12 or further includes a component also belongs to the scope of the present inventive concepts. For example, the processor 500 may further include a (local) cache memory block capable of storing an instruction (or a thread), data, the context queue CQ. For example, the context queue CQ may have a queue structure, but the scope of the present inventive concepts are not limited thereto. For example, it should be understood that some example embodiments in which the context queue CQ is implemented with a stack or a priority queue or in any other data structure also belongs to the scope of the present inventive concepts.

FIG. 13 is a block diagram illustrating an electronic device, according to some example embodiments. Referring to FIG. 13, an electronic device 1000 according to some example embodiments of the present inventive concepts may include an image processing unit 1100, a wireless transceiver unit 1200, an audio processing unit 1300, a battery 1400, a non-volatile memory device 1500, a user interface 1600, and a system-on-chip (SoC) 1700. In some example embodiments, the electronic device 1000 may operate under control of the SoC 1700.

The image processing unit 1100 includes a lens 1110, an image sensor 1120, an image processor 1130, and a display unit 1140. The image processor 1130 may convert a real image into image data through the lens 1110 and the image sensor 1120. The display unit 1140 may display an image data signal generated by the image processor 1130 or image data to be provided to the user. The display unit 1140 may be implemented with a liquid crystal display (LCD), an organic light emitting diode (OLED), etc. In some example embodiments, when the LCD or the OLED is implemented in a touch screen manner, the display unit 1140 may operate together with the user interface 1600.

The wireless transceiver unit 1200 include an antenna 1210, a transceiver 1220, and a modulator/demodulator (modem) 1230. The wireless transceiver unit 1200 may perform a wireless communication function. The transceiver 1220 may adjust a frequency of a signal to be transmitted and/or sent through the antenna 1210 or may amplify the signal and may adjust a frequency of a signal received through the antenna 1210 or may amplify the signal. The modem 1230 may include a transmitter encoding and modulating a signal to be transmitted and/or sent and a receiver demodulating and decoding a signal received through the antenna 1210. The antenna 1210 and the modem 1230 of the wireless transceiver unit 1200 may process signals exchanged with an external device/system, based on at least one of various wireless communication protocols: long term evolution (LTE), worldwide interoperability for microwave access (WiMax), global system for mobile communication (GSM), code division multiple access (CDMA), Bluetooth, near field communication (NFC), wireless fidelity (Wi-Fi), and radio frequency identification (RFID).

The audio processing unit 1300 includes an audio processor 1310, a microphone 1320, and a speaker 1330. The audio processing unit 1300 may constitute a codec, and the codec may include a data codec and an audio codec. The data codec may process packet data or the like, and the audio codec may process a voice and an audio signal such as a multimedia file. In some example embodiments, the audio processing unit 1300 may perform a function of converting and replaying a digital audio signal received by the modem 1230 into an audio analog signal through the audio codec or converting an analog audio signal generated from the microphone 1320 into a digital audio signal so as to be transmitted and/or sent to the modem 1230. The codec may be provided separately or may be included in the SoC 1700.

The battery 1400 may provide a power necessary for the operation of the electronic device 1000. In FIG. 13, the electronic device 1000 is illustrated as receiving the power from the battery 1400, but it should be understood that some example embodiments in which an external power source performs a role of the battery 1400 also belongs to the scope of the present inventive concepts. The non-volatile memory device 1500 may store data of the electronic device 1000. For example, the non-volatile memory device 1500 may be a NAND flash memory device or may include the NAND flash memory device. The non-volatile memory device 1500 may be provided as a memory card (e.g., MMC, eMMC, SD, or micro SD) according to some example embodiments.

The user interface 1600 may receive an input from the outside or may generate an output to the outside. For example, the user interface 1600 may receive an input through an input device such as a keyboard or a mouse. In some example embodiments, the user interface 1600 may include a driver for receiving the input from the input devices. In some example embodiments, the user interface 1600 may generate an output while operating with the display unit 1140 or the audio processing unit 1300 together.

The SoC 1700 may drive an application program or an operating system. In some example embodiments, the SoC 1700 may include a processor such as a general purpose processor or a specific purpose processor. In some example embodiments, the SoC 1700 may control the components of the electronic device 1000. The SoC 1700 may include an PMIC 1710. The PMIC 1710 may be supplied with a voltage from the battery 1400 and may convert the level of the supplied voltage. The PMIC 1710 may provide the converted voltage level to the respective components of the electronic device 1000.

In some example embodiments, the SoC 1700 may include one or more processor or an IP block, and the one or more processors or the IP block may execute, run, or implement an operating system or an application program. In some example embodiments, at least one of the image processor 1130, the modem 1230, the audio processor 1330, the non-volatile memory device 1500, or the SoC 1700 may include the processor described with reference to FIGS. 1 to 12.

The components of the electronic device 1000 illustrated in FIG. 13 are provided as an example, and the scope of the present inventive concepts are not limited thereto. For example, the electronic device 1000 may further include a volatile memory device as a system memory, and the volatile memory device may operate under control of the SoC 1700. In some example embodiments, the electronic device 1000 may not include some of the components of FIG. 13. For example, the electronic device 1000 may not include the image processing unit 1100.

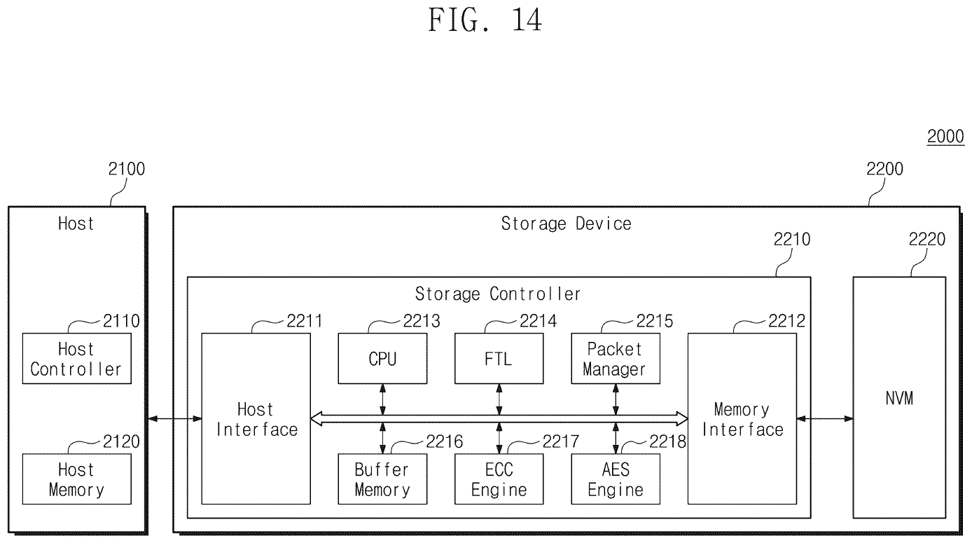

FIG. 14 is a block diagram of a host storage system 2000 according to some example embodiments. The host storage system 2000 may include a host 2100 and a storage device 2200. In some example embodiments, the storage device 2200 may include a storage controller 2210 and an NVM 2220. According to some example embodiments, the host 2100 may include a host controller 2110 and a host memory 2120. The host memory 2120 may serve as a buffer memory configured to temporarily store data to be transmitted and/or sent to the storage device 2200 or data received from the storage device 2200.

The storage device 2200 may include storage media configured to store data in response to requests from the host 2100. For example, the storage device 2200 may include at least one of an SSD, an embedded memory, and a removable external memory. In some example embodiments, when the storage device 2200 is an SSD, the storage device 2200 may be a device that conforms to an NVMe standard. In some example embodiments, when the storage device 2200 is an embedded memory or an external memory, the storage device 2200 may be a device that conforms to a UFS standard or an eMMC standard. Each of the host 2100 and the storage device 2200 may generate a packet according to an adopted standard protocol and transmit and/or send the packet.

In some example embodiments, when the NVM 2220 of the storage device 2200 includes a flash memory, the flash memory may include a 2D NAND memory array or a 3D (or vertical) NAND (VNAND) memory array. In some example embodiments, the storage device 2200 may include various other kinds of NVMs. For example, the storage device 2200 may include magnetic RAM (MRAM), spin-transfer torque MRAM, conductive bridging RAM (CBRAM), ferroelectric RAM (FRAM), PRAM, RRAM, and various other kinds of memories.

According to some example embodiments, the host controller 2110 and the host memory 2120 may be implemented as separate semiconductor chips. Alternatively, in some embodiments, the host controller 2110 and the host memory 2120 may be integrated in the same semiconductor chip. For example, the host controller 2110 may be any one of a plurality of modules included in an application processor (AP). The AP may be implemented as a System on Chip (SoC). In some example embodiments, the host memory 2120 may be an embedded memory included in the AP or an NVM or memory module located outside the AP.

The host controller 2110 may manage an operation of storing data (e.g., write data) of a buffer region of the host memory 2120 in the NVM 2220 or an operation of storing data (e.g., read data) of the NVM 2220 in the buffer region.

The storage controller 2210 may include a host interface 2211, a memory interface 2212, and a CPU 2213. In some example embodiments, the storage controllers 2210 may further include a flash translation layer (FTL) 2214, a packet manager 2215, a buffer memory 2216, an error correction code (ECC) engine 2217, and an advanced encryption standard (AES) engine 2218. The storage controllers 2210 may further include a working memory (not shown) in which the FTL 2214 is loaded. The CPU 2213 may execute the FTL 2214 to control data write and read operations on the NVM 2220.

The host interface 2211 may transmit and/or send and receive packets to and from the host 2100. A packet transmitted and/or sent from the host 2100 to the host interface 2211 may include a command or data to be written to the NVM 2220. A packet transmitted and/or sent from the host interface 2211 to the host 2100 may include a response to the command or data read from the NVM 2220. The memory interface 2212 may transmit and/or send data to be written to the NVM 2220 to the NVM 2220 or receive data read from the NVM 2220. The memory interface 2212 may be configured to comply with a standard protocol, such as Toggle or open NAND flash interface (ONFI).

In some example embodiments, the host 2100 or the storage controller 2210 may include the processor in FIGS. 1 to 12. For example, CPU 2213 may include or be implemented as the processor in FIGS. 1 to 12.

The FTL 2214 may perform various functions, such as an address mapping operation, a wear-leveling operation, and a garbage collection operation. The address mapping operation may be an operation of converting a logical address received from the host 2100 into a physical address used to actually store data in the NVM 2220. The wear-leveling operation may be a technique for preventing and/or mitigating excessive deterioration of a specific or alternatively, a desired block by allowing blocks of the NVM 2220 to be uniformly used. As an example, the wear-leveling operation may be implemented using a firmware technique that balances erase counts of physical blocks. The garbage collection operation may be a technique for ensuring usable capacity in the NVM 2220 by erasing an existing block after copying valid data of the existing block to a new block.

The packet manager 2215 may generate a packet according to a protocol of an interface, which consents to the host 2100, or parse various types of information from the packet received from the host 2100. In some example embodiments, the buffer memory 2216 may temporarily store data to be written to the NVM 2220 or data to be read from the NVM 2220. Although the buffer memory 2216 may be a component included in the storage controllers 2210, in some example embodiments, the buffer memory 2216 may be outside the storage controllers 2210.

The ECC engine 2217 may perform error detection and correction operations on read data read from the NVM 2220. For example, the ECC engine 2217 may generate parity bits for write data to be written to the NVM 2220, and the generated parity bits may be stored in the NVM 2220 together with write data. During the reading of data from the NVM 2220, the ECC engine 2217 may correct an error in the read data by using the parity bits read from the NVM 2220 along with the read data, and output error-corrected read data.

The AES engine 2218 may perform at least one of an encryption operation and a decryption operation on data input to the storage controllers 2210 by using a symmetric-key algorithm.

In some example embodiments, components which are described with reference to the terms “~unit”, “~module”, “~block”, “~er or ~or”, “circuit”, “circuitry”, etc., and function blocks which are illustrated in drawings will be implemented in the form of software or hardware or in the form of a combination thereof. In some example embodiments, the software may be a machine code, firmware, an embedded code, a source code, application software, and/or a combination thereof or may include the listed components. In some example embodiments, the hardware may include an electrical circuit, an electronic circuit (e.g., an analog circuit or a digital circuit), a processor, a computer, an integrated circuit, integrated circuit cores, a pressure sensor, an inertial sensor, a microelectromechanical system (MEMS), a passive element, and/or a combination thereof or may include the listed components.

According to some example embodiments of the present inventive concepts, a processor capable of efficiently managing an operation whose latency is long and shortening a total of operation time, an operation method thereof, and/or a system including the same are provided.

As described herein, any devices, electronic devices, modules, units, and/or portions thereof according to any of the example embodiments, and/or any portions thereof may include, may be included in, and/or may be implemented by one or more instances of processing circuitry such as hardware including logic circuits; a hardware/software combination such as a processor executing software; or a combination thereof. For example, the processing circuity more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a solid state drive (SSD), storing a program of instructions, and a processor (e.g., CPU) configured to execute the program of instructions to implement the functionality and/or methods performed by some or all of any devices, electronic devices, modules, units, and/or portions thereof according to any of the example embodiments.

As described herein, any or all of the elements described with reference to the figures may communicate with any or all other elements described with reference to the figures. For example, any element may engage in one-way and/or two-way and/or broadcast communication with any or all other elements in the figures, to transfer and/or exchange and/or receive information such as but not limited to data and/or commands, in a manner such as in a serial and/or parallel manner, via a bus such as a wireless and/or a wired bus (not illustrated). The information may be encoded in various formats, such as in analog format and/or in a digital format.

While some example embodiments the present inventive concepts have been described with reference to some example embodiments thereof, it will be apparent to those of ordinary skill in the art that various changes and modifications may be made thereto without departing from the spirit and scope of the present inventive concepts as set forth in the following claims.

What is claimed is:

1. A processor, comprising:
a first processing core block configured to execute one or more first instructions and write first information of a first operation and first data on a first context; and
a response handling block configured to receive the first context from the first processing core block and manage a first response corresponding to the first operation indicated by a last instruction of the one or more first instructions lastly executed by the first processing core block, wherein:
the first processing core block inputs the first context to the response handling block and performs context switching from the first context to a second context in response to the last instruction lastly executed by the first processing core block indicating a portion of the first operation as having a longer latency than a threshold value, and
the response handling block receives the first response, writes the first response in the first context, and updates the first context.

2. The processor of claim 1, wherein, after the first processing core block performs the context switching, the first processing core block is further configured to,
write second information of a second operation and second data on the second context; and
execute one or more second instructions.

3. The processor of claim 1, wherein the response handling block includes:
a context capture circuit configured to manage one or more contexts received by the response handling block;
a response detection circuit configured to receive and manage one or more responses, each response of the one or more responses corresponding to an indicated operation indicated by a lastly executed instruction of each context of the one or more contexts received by the response handling block; and
a context update circuit configured to update the one or more contexts received by the response handling block based on the one or more responses.

4. The processor of claim 3, wherein the response detection circuit includes a response queue configured to store the one or more responses.

5. The processor of claim 4, wherein
the response detection circuit is further configured to receive and manage the first response, and
the context capture circuit is further configured to manage the first context.

6. The processor of claim 5, wherein the context update circuit is configured to:
receive the first response from the response detection circuit;
receive the first context from the context capture circuit; and
write the first response on the first context to update the first context.

7. The processor of claim 1, further comprising:
a context managing block configured to manage one or more contexts, the one or more contexts including the first context and the second context.

8. The processor of claim 7, wherein the context managing block includes a context queue configured to store the first context and the second context.

9. The processor of claim 7, wherein the first context of the one or more contexts includes:
a processor identifier pointing out the first processing core block configured to receive the first context of the one or more contexts;
an entry pointer pointing out a first instruction to be executed by the first processing core block configured to receive the first context of the one or more contexts;
a plurality of registers configured to store the first data used for the first operation of the first processing core block configured to receive the first context of the one or more contexts; and
a special function register including the first information of the first context of the one or more contexts and second information of the first processing core block configured to receive the first context of the one or more contexts.

10. The processor of claim 9, wherein the special function register includes third information of a thread, the thread belonging to the first context sent to the response handling block and is lastly executed by the first processing core block.

11. The processor of claim 10, wherein
the third information of the thread that is lastly executed by the first processing core block includes a target register where the first response is to be written, and
the response handling block is configured to write the first response in the target register of the first context.

12. The processor of claim 1, wherein the first operation having the longer latency than the threshold value is a data load operation in which a cache miss occurs.

13. An operation method of a processor, the method comprising:
executing one or more first instructions of one or more first tasks;
switching a first context to a second context, the first context including first information of a first operation and storing first data;
writing second information of a second operation and second data in the second context;
waiting for a first response of the first operation; and
executing one or more second instructions of one or more second tasks, wherein:
a last instruction lastly executed from among the one or more first instructions indicates a portion of the first operation having a longer latency than a threshold value, and
the execution of the one or more second instructions and the waiting for the first response of the first operation are performed to at least partially overlap each other.

14. The method of claim 13, wherein the first operation having the longer latency than the threshold value is a data load operation in which a cache miss occurs.

15. The method of claim 13, wherein, after receiving the first response, the method includes:
writing the first response on the first context to update the first context.

16. The method of claim 15, wherein the processor includes:
a processing core block configured to execute the one or more first instructions and the one or more second instructions; and
a response handling block configured to wait for the first response and update the first context.

17. The method of claim 16, wherein the first context includes:
a processor identifier pointing out the processing core block configured to receive the first context; and
a special function register including the first information of the first operation indicated by the last instruction lastly executed from among the one or more first instructions.

18. An electronic device, comprising:
a processor configured to control the electronic device and perform a process for a first operation of the electronic device; and
a memory configured to store an instruction and first data for a second operation of the processor,
the processor including,
a processing core block configured to execute one or more first instructions and write information of a third operation and second data on a first context; and
a response handling block configured to receive the first context from the processing core block and manage a first response corresponding to the third operation indicated by a last instruction of the one or more first instructions lastly executed by the processing core block.

19. The electronic device of claim 18, wherein, the processing core block is configured to input the first context to the response handling block and perform context switching from the first context to a second context in response to the last instruction lastly executed by the processing core block indicating that a portion of the third operation has a longer latency than a threshold value; and
wherein the response handling block is further configured to receive the first response, write the first response in the first context, and update the first context.

20. The electronic device of claim 19, wherein the first operation having the longer latency than the threshold value is a data load operation in which a cache miss occurs.
